(19) United States
(12) Patent Application Publication
(10) Pub. No.: US 2026/0293956 A1
(43) Pub. Date: Oct. 1, 2026

(54) NUTRITIONAL COMPOSITION

(71) Applicant: SOCIÉTÉ DES PRODUITS NESTLÉ S.A., Vevey (CH)

(72) Inventors: Kieran JAMES, Bern (CH); Norbert SPRENGER, Savigny (CH); Peter ERDMANN, Bern (CH); Florac DE BRUYN, Lausanne (CH); Hanne Lore Paula TYTGAT, Zurich (CH)

(21) Appl. No.: 19/477,424

(22) PCT Filed: Apr. 26, 2024
(86) PCT No.: PCT/EP2024/061695

§ 371 Date: Oct. 21, 2025

(30) Foreign Application Priority Data
Apr. 28, 2023 (EP) 23170885.0

(51) Int. Cl. A23L 33/00; A23L 33/125; A23L 33/135; A23L 33/18; A23L 33/19; A23L 33/21

(52) U.S. Cl. CPC A23L 33/40; A23L 33/125; A23L 33/135; A23L 33/18; A23L 33/19; A23L 33/21

(57) ABSTRACT

The present invention provides a combination comprising or consisting of lacto-N-fucopentaose-1 (LNFP-I), a LNFP-1 metabolizing Bifidobacterium, for example Bifidobacterium longum subsp. infantis and a galactose source, or a nutritional composition comprising lacto-N-fucopentaose-1 (LNFP-I), aa LNFP-1 metabolizing Bifidobacterium, for example Bifidobacterium longum subsp. infantis and a galactose source, wherein the galactose source consists of a structure of Formula (I): Hex1(n)-Hex2(m) (Formula I) wherein: Hex1 is galactose, Hex2 is galactose or glucose, n=1-9, and m=1.

### FIELD OF THE INVENTION

The present invention provides a nutritional composition comprising lacto-N-fucopentaose-I (LNFP-I), a LNFP-1 metabolizing Bifidobacterium, for example Bifidobacterium longum subsp. infantis (B. infantis) and a galactose source. The invention also provides the use of the nutritional composition for increasing the levels of indole-3-lactic acid (ILA) in the gastrointestinal tract of a subject or modulating the microbiota of a subject. The present invention also provides applications of the nutritional composition in human health.

### BACKGROUND TO THE INVENTION

Human milk oligosaccharides (HMOs) have become the subject of much interest in recent years due to their roles in numerous biological processes occurring in the human organism. Mammalian milk contains at least 130 of these complex oligosaccharides (Urashima et al, Milk Oligosaccharides, Nova Biomedical Books, New York, 2011, ISBN: 978-1-61122-831-1).

Evidence is accumulating that the human intestinal microbiota plays a major role in health and disease. When the composition of the intestinal microbiota is thrown off balance, the human host can suffer consequences. Recent research has implicated intestinal microbiota imbalances in individual disorders as diverse as cancer, obesity, inflammatory bowel disease, psoriasis, asthma, and possibly even autism. Individual non-digestible fibres, including HMOs, are known to positively modulate the microbiota, and they are of increasing interest for treating one or more of such disorders.

Infancy, especially the first weeks, 3 months, 6 months or 12 months of life is a critical period for the establishment of a balanced gut microbiota. It is known that the modulation of the gut microbiota during infancy and early childhood can prospectively have a significant influence in the future health status of the body. For example, the gut microbiome can have an influence on the development of a strong immune system later in life, as well as normal growth, and even on the development of obesity later in life.

Similarly, a healthy intestinal flora is an indicator of the health of an infant and an altered intestinal microbiota can be an indicator (and/or a cause) of abnormal health events such as diarrhea, under-absorption of nutrients, colic, altered sleep and/or altered growth and development. It is known that the mode of delivery can also affect the initial gut microbiota of infants: infants delivered by Caesarean section (C-section) have been shown to have a different gut microbiota compared to vaginally-delivered infants.

The gut microbiome and its evolution during the development of the infant or young child is, however, a fine balance between the presence and prevalence (amount) of many populations of gut bacteria. Some gut bacteria are classified as “generally positive” while others are “generally negative” (or pathogenic) regarding their effect on the overall health of the infant. Certain species of “generally positive” bacteria, such as bifidobacteria, may be under-represented in infants fed conventional infant formula in comparison to breastfed infants. Similarly, some bacterial populations are considered pathogenic and should remain at a low prevalence in the gut microbiota.

Bifidobacterium longum subsp. infantis has been demonstrated to predominate in the gut microbiota of breastfed infants and to benefit the host by accelerating maturation of the immune response, balancing the immune system to suppress inflammation, improving intestinal barrier function, and increasing short-chain fatty acid (SCFA) production. Reduced abundance of Bifidobacterium species in infants and young children has been correlated to chronic diseases, including asthma and obesity, as well as to lower vaccine response. Researchers have postulated that loss of Bifidobacterium species in the infant gut in populations of developed countries is linked to increased incidence of allergic and autoimmune diseases.

Increasing the abundance of Bifidobacterium species or specifically Bifidobacterium longum subsp. infantis in the gut microbial ecosystem through exogenous administration may be difficult to achieve, especially in formula-fed infants. Administration of a probiotic via nutritional compositions, such as infant formulae, typically aims to promote its engraftment in the gut microbiome so that it can elicit the desired benefits associated with said probiotic. The wide diversity of the microbial community in the gut makes probiotic engraftment challenging.

Bifidobacterium longum subsp. infantis has the ability to efficiently catabolise a wide array of HMO structures, in particular fucosylated HMO glycans. Among the commonly-occurring fucosylated HMO glycans in breastmilk is the pentasaccharide lacto-N-fucopentaose I (LNFP-I). Although HMO glycans are already included as prebiotics in a number of infant formulae and supplements, LNFP-I has not been included in such compositions due to the difficulty of its production.

Indole metabolites are known to have multiple benefits in the gut environment (Huang et al., 2021, Scientific Reports, 11: 8088), in particular for immune and anti-inflammatory effects. Indole-3-lactic acid (ILA) is one such molecule, which has been shown to be produced by a a LNFP-1 metabolizing Bifidobacterium, for example Bifidobacterium longum subsp. infantis from tryptophan.

Due to the loss of Bifidobacterium species in the infant gut and low breast-feeding rates, there is a need to provide infants with both HMOs and HMO-utilizing bacteria such as a LNFP-1 metabolizing Bifidobacterium, for example by B. longum subsp. infantis to support a healthy microbiome for long-term health.

### SUMMARY OF THE INVENTION

The present inventors have surprisingly found that the combination of the human milk oligosaccharide (HMO) lacto-N-fucopentaose-I (LNFP-I) and a galactose source having the structure of Formula I increases the biosynthesis of indole-3-lactic acid (ILA) by a LNFP-1 metabolizing Bifidobacterium, for example by Bifidobacterium longum subsp. infantis. Thus, the invention provides a nutritional composition comprising LNFP-I, a LNFP-1 metabolizing Bifidobacterium, for example Bifidobacterium longum subsp. infantis, and a galactose source having the structure of Formula I. The present inventors have found that these specific combinations are particularly effective in increasing biosynthesis of ILA by a LNFP-1 metabolizing Bifidobacterium, for example Bifidobacterium longum subsp. infantis. Both a LNFP-1 metabolizing Bifidobacterium, for example Bifidobacterium longum subsp. infantis, and indole metabolites, such as ILA, have been demonstrated to benefit the host and gut environment in multiple ways, including balancing the immune system to suppress inflammation. Thus, the invention provides a way to increase the production of a metabolite (i.e. ILA) with known benefits such as anti-inflammatory effects in the intestine. Hence, the nutritional composition of the invention would be expected to provide increased beneficial anti-inflammatory effects by increasing the production of ILA in the gastrointestinal tract of a subject fed the nutritional composition.

Accordingly, in a first aspect, the invention provides a nutritional composition comprising lacto-N-fucopentaose-I (LNFP-I), a LNFP-1 metabolizing Bifidobacterium, for example Bifidobacterium longum subsp. infantis, and a galactose source, wherein the galactose source consists of a structure of Formula I:

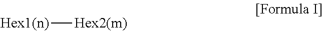

wherein:
Hex1 is galactose,
Hex2 is galactose or glucose,

$$n = 1 - 9 , and$$

$$m = 1.$$

In some preferred embodiments, the LNFP-1 metabolizing Bifidobacterium is Bifidobacterium longum subsp. infantis.

Accordingly, in further aspect, the invention provides a nutritional composition comprising lacto-N-fucopentaose-I (LNFP-I), Bifidobacterium longum subsp. infantis, and a galactose source, wherein the galactose source consists of a structure of Formula I:

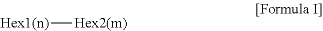

wherein:
Hex1 is galactose,
Hex2 is galactose or glucose,

$$n = 1 - 9 , and$$

$$m = 1.$$

In some embodiments, the galactose source is selected from galacto-oligosaccharides (GOS), Bovine Milk-derived Oligosaccharides (BMOS) and mixtures thereof.

In some embodiments, the composition further comprises a protein source.

In some embodiments, the protein source is an intact protein source. Suitably, the intact protein source comprises:
a) skimmed milk and demineralized, caseino-glyco-macropeptide (CGMP)-reduced-whey;
b) skimmed milk and CGMP-free whey, such as acid or native whey; or
c) skimmed milk and alpha-lactalbumin-enriched whey protein.

Suitably, the CGMP-free whey is demineralized CGMP-free whey, such as demineralized CGMP-free acid or native whey.

In some embodiments, the protein source is a partially hydrolysed protein source. Suitably, the partially hydrolysed protein source comprises:
a) CGMP-free whey protein isolate and demineralized sweet whey protein concentrate; or
b) demineralized CGMP-reduced sweet whey and demineralized sweet whey.

In some embodiments, LNFP-I is present in a total amount of from 25 mg/L to 5000 mg/L of the nutritional composition or of from 0.02-3.75 g/100 g of the nutritional composition.

In some embodiments, LNFP-I is the most abundant HMO in the nutritional composition.

In some embodiments, LNFP-I is the most abundant fucosylated oligosaccharide in the nutritional composition.

In some embodiments, the nutritional composition is an infant formula, a starter infant formula, a follow-on or follow-up infant formula, a baby food, an infant cereal composition, a growing-up milk, a fortifier or a supplement.

In a further aspect, the invention provides the use of a nutritional composition of the invention for increasing the levels of indole-3-lactic acid (ILA) in the gastrointestinal tract of a subject.

In a further aspect, the invention provides the use of a nutritional composition of the invention for modulating the microbiota of a subject. Suitably, modulating the microbiota of a subject comprises increasing the abundance of Bifidobacteriaceae and/or a a LNFP-1 metabolizing Bifidobacterium, for example Bifidobacterium longum subsp. infantis, in the gastrointestinal tract of the subject.

In some embodiments, the subject is an infant, a young child or a child.

In a further aspect, the invention provides a nutritional composition according to the invention for use in:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject.

In a further aspect, the invention provides a nutritional composition according to the invention for use in:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject;
by increasing the levels of ILA in the gastrointestinal tract of the subject.

In some embodiments, the composition is for use in preventing and/or treating viral and/or bacterial infections in a subject. Suitably, the composition is for use in preventing and/or treating viral infections in a subject. Suitably, the composition is for use in preventing and/or treating bacterial infections in a subject. Suitably, the composition is for use in preventing and/or treating viral and bacterial infections in a subject.

In some embodiments, the composition is for use in preventing and/or reducing inflammation in the intestine of a subject and/or promoting a healthy immune system in a subject. Suitably, the composition is for use in preventing and/or reducing inflammation in the intestine of a subject. Suitably, the composition is for use in promoting a healthy immune system in a subject. Suitably, the composition is for use in preventing and/or reducing inflammation in the intestine of a subject and/or promoting a healthy immune system in a subject.

In some embodiments, modulating the microbiota of a subject comprises increasing the abundance of Bifidobacteriaceae and/or a LNFP-1 metabolizing Bifidobacterium, for example Bifidobacterium longum subsp. infantis, in the gastrointestinal tract of the subject.

In some embodiments, the subject is an infant, a young child or a child.

In a further aspect, the invention provides a combination comprising or consisting of lacto-N-fucopentaose-I (LNFP-I), a LNFP-1 metabolizing Bifidobacterium, for example Bifidobacterium longum subsp. infantis, and a galactose source, wherein the galactose source consists of the structure of Formula I, and in further aspects its uses and methods using it.

In a further aspect, the invention provides a combination comprising or consisting of lacto-N-fucopentaose-I (LNFP-I), Bifidobacterium longum subsp. infantis, and a galactose source, wherein the galactose source consists of the structure of Formula I, and in further aspects its uses and methods using it.

In a further aspect, the invention provides a combination comprising or consisting of lacto-N-fucopentaose-I (LNFP-I), the strain Bifidobacterium longum subsp. infantis LMG 11588 (also known as ATCC 17930) and a galactose source, wherein the galactose source consists of the structure of Formula I, and in further aspects its uses and methods using it.

In some embodiments, LNFP-I is the most abundant HMO in the combination.

In some embodiments, LNFP-I is the only HMO in the combination.

In some embodiments, LNFP-I is the most abundant fucosylated oligosaccharide in the combination.

In a further aspect, the invention provides a nutritional composition comprising the combination, its uses and methods using it.

In a further aspect, the invention provides a nutritional composition comprising a combination, the combination comprising or consisting of lacto-N-fucopentaose-I (LNFP-I), a LNFP-1 metabolizing Bifidobacterium, for example the strain Bifidobacterium longum subsp. infantis LMG 11588 (also known as ATCC 17930) and a galactose source, wherein the galactose source consists of the structure of Formula I, and in further aspects its uses and methods using it.

In a further aspect, the invention provides a nutritional composition comprising a combination, the combination comprising or consisting of lacto-N-fucopentaose-I (LNFP-I), Bifidobacterium longum subsp. infantis and a galactose source, wherein the galactose source consists of the structure of Formula I, and in further aspects its uses and methods using it.

In a further aspect, the invention provides a nutritional composition comprising a combination, the combination comprising or consisting of lacto-N-fucopentaose-I (LNFP-I), Bifidobacterium longum subsp. infantis LMG 11588 (also known as ATCC 17930) and a galactose source, wherein the galactose source consists of the structure of Formula I, and in further aspects its uses and methods using it.

### BRIEF DESCRIPTION OF THE FIGURES

FIG. 1: End of fermentation plate counts for B. infantis following incubation with the various ingredient combinations tested. Each bar represents mean values for three biological replicates per variant. Error bars represent standard deviation.

FIG. 2: End of fermentation levels of supernatant indole-3-lactic acid (ILA) following incubation with the various ingredient combinations tested, as detected by UHPLC-HRMS. ILA levels are given in μM concentration. Each box plot represents the distribution of values for three biological replicates per variant. Parentheses represent T-values for each variant compared to the variant GOS+LNFP-I+WPC (HA); p<0.05.

FIG. 3: Acetate, butyrate, and total SCFA produced microbially during the fecal fermentation of LNFP-I, Bifidobacterium longum subsp. infantis LMG11588 and WPC (HA) conducted using Cryptobiotix's ex-vivo SIFR protocol. Adding LNFP-I increases acetate, butyrate, and total SCFA. The levels of SCFA is further boosted by the addition of Bifidobacterium longum subsp. infantis LMG 11588 and WPC (HA).

FIG. 4: Butyrate and PLA produced microbially during the fecal fermentation of B. infantis LMG11588 and WPC (HA) conducted using Cryptobiotix's ex-vivo SIFR protocol. A synergy between WPC (HA) and Bifidobacterium longum subsp. infantis LMG 11588 was observed even in the absence of LNFP-I.

FIG. 5: Biomass growth with LNFP-I and Bifidobacterium longum subsp. infantis infantis LMG 11588 (NCC3039) compared to other HMOs. LNFP-I presents a unique diauxic shift. Experiments were conducted in triplicate, with the average being depicted.

### DETAILED DESCRIPTION OF THE INVENTION

### Definitions

As used herein, the following terms have the following meanings.

The term “subject” refers to an infant, young child, child, an infant small for gestational age (SGA) or a preterm.

The term “infant” means a child under the age of 12 months.

The expression “young child” means a child aged between one and three years, also called toddler.

The term “child” means a child aged between three and twelve years. Preferably, the term “child” means a child aged between three and six years.

A “preterm” or “premature” subject means an infant or young child who was not born at term. Generally it refers to an infant or young child born prior 36 weeks of gestation.

By the expression “small for gestational age” or “SGA” it is referred to an infant or young child who is smaller in size than normal for their gestational age at birth, most commonly defined as a weight below the 10th percentile for the gestational age. In some embodiments, SGA may be associated with intrauterine growth restriction (IUGR), which refers to a condition in which a foetus is unable to achieve its potential size.

By the expression “low birth weight”, it should be understood as any body weight under 2500 g at birth.

The expression “nutritional composition” means a composition which nourishes a subject. This nutritional composition is usually to be taken orally or intravenously. It may include a lipid or fat source, a carbohydrate source and/or a protein source. In a particular embodiment the nutritional composition is a ready-to-drink composition such as a ready-to-drink formula.

In a particular embodiment, the nutritional composition of the present invention is a “synthetic nutritional composition”. The expression “synthetic nutritional composition” means a mixture obtained by chemical and/or biological means, which can be chemically identical to the mixture naturally occurring in mammalian milks (i.e. the synthetic nutritional composition is not breast milk).

The expression “infant formula” as used herein refers to a foodstuff intended for particular nutritional use by infants during the first months of life and satisfying by itself the nutritional requirements of this category of person (Article 2(c) of the European Commission Directive 91/321/EEC 2006/141/EC of 22 Dec. 2006 on infant formulae and follow-on formulae). It also refers to a nutritional composition intended for infants and as defined in Codex Alimentarius (Codex STAN 72-1981) and Infant Specialities (incl. Food for Special Medical Purpose).

The expression “infant formula” encompasses both “starter infant formula” and “follow-up formula” or “follow-on formula”.

A “follow-up formula” or “follow-on formula” is given from the 6th month onwards and includes “growing-up milk”. It constitutes the principal liquid element in the progressively diversified diet of this category of person.

The expression “growing-up milk” (or “GUM”) refers to a milk-based drink generally with added vitamins and minerals, that is intended for young children or children.

The expression “baby food” means a foodstuff intended for particular nutritional use by infants or young children during the first years of life.

The expression “infant cereal composition” means a foodstuff intended for particular nutritional use by infants or young children during the first years of life.

The term “fortifier” refers to liquid or solid nutritional compositions suitable for mixing with breast milk or infant formula.

The expression “weaning period” means the period during which the mother's milk is substituted by other food in the diet of an infant or young child.

The “mother's milk” should be understood as the breast milk or the colostrum of the mother.

An “oligosaccharide” is a saccharide polymer containing a small number (typically three to ten) of simple sugars (monosaccharides).

The term “HMO” or “HMOs” refers to human milk oligosaccharide(s). These carbohydrates are resistant to enzymatic hydrolysis by digestive enzymes (e.g. pancreatic and/or brush border), indicating that they may display functions not directly related to their caloric value. It has especially been illustrated that they play a vital role in the early development of infants and young children, such as the maturation of the immune system. Many different kinds of HMOs are found in the human milk. Each individual oligosaccharide is based on a combination of glucose, galactose, sialic acid (N-acetylneuraminic acid), fucose and/or N-acetylglucosamine with many and varied linkages between them, thus accounting for the enormous number of different oligosaccharides in human milk—over 130 such structures have been identified so far. Almost all of them have a lactose moiety at their reducing end while sialic acid and/or fucose (when present) occupy terminal positions at the non-reducing ends. The HMOs can be acidic (e.g. charged sialic acid containing oligosaccharide) or neutral (e.g. fucosylated oligosaccharide). Some examples of HMOs are the fucosylated oligosaccharides, the N-acetylated oligosaccharides and/or the sialylated oligosaccharides.

A “fucosylated oligosaccharide” is an oligosaccharide having a fucose residue. It has a neutral nature. Some examples are LNFP-I (lacto-N-fucopentaose 1), 2′-FL (2′ fucosyllactose), 3-FL (3-fucosyllactose). Lacto-N-fucopentaose I may be referred to as LNFP-1 or LNFP-I.

The expressions “fucosylated oligosaccharides comprising an alpha-1,2-fucosyl-epitope” and “2-fucosylated oligosaccharides” encompass fucosylated oligosaccharides with a certain homology of form since they contain an alpha-1,2-fucosyl-epitope, therefore a certain homology of function can be expected.

The expression “N-acetylated oligosaccharide(s)” encompasses both “N-acetyl-lactosamine” and “oligosaccharide(s) containing N-acetyl-lactosamine”. They are neutral oligosaccharides having an N-acetyl-lactosamine residue. Suitable examples are LNT (lacto-N-tetraose), para-lacto-N-neohexaose (para-LNnH), LNnT (lacto-N-neotetraose) and any combinations thereof. Other examples are lacto-N-hexaose, lacto-N-neohexaose, para-lacto-N-hexaose, para-lacto-N-neohexaose, lacto-N-octaose, lacto-N-neooctaose, iso-lacto-N-octaose, para-lacto-N-octaose and lacto-N-decaose.

A “sialylated oligosaccharide” is a charged sialic acid containing oligosaccharide, i.e. an oligosaccharide having a sialic acid residue. It has an acidic nature. Some examples are 3′-SL (3′-sialyllactose) and 6′-SL (6′-sialyllactose). The expressions “sialylated oligosaccharide” and “sialyllactose (SL)” can be used interchangeably. The trisaccharide sialyllactose consists of lactose at the reducing terminus and one sialic acid residue at the non-reducing end via an alpha-2,3 binding or alpha-2,6 binding, resulting in 3′-SL and 6′-SL, respectively.

A “precursor of HMO” is a key compound that intervenes in the manufacture of HMO, such as sialic acid and/or fucose.

The term “GOS” as used herein means “Galacto-oligosaccharide”. Galacto-oligosaccharides (GOS) as used herein typically consist of β-linked galactose moieties with galactose or glucose at the reducing end. Such GOS contains β-(1→2), β-(1→3), β-(1→4), or β-(1→6) linked galactose moieties and may have a degree of polymerization (DP) of 3-8 galactose units. The term GOS is therefore preferably referred to as oligosaccharide(s) comprising at least three galactose units, more preferably as oligosaccharide(s) comprising at least four galactose units, preferably having a degree of polymerization (DP) of 3-8 galactose units.

The nutritional composition of the present invention can be in solid form (e.g. powder) or in liquid form. The amount of the various ingredients (e.g. the oligosaccharides) can be expressed in g/100 g of composition on a dry weight basis when it is in a solid form, e.g. a powder, or as a concentration in g/L of the composition when it refers to a liquid form (this latter also encompasses liquid composition that may be obtained from a powder after reconstitution in a liquid such as milk, water, e.g. a reconstituted infant formula or a follow-on/follow-up formula or a growing-up milk or an infant cereal product or any other formulation designed for infant nutrition).

The expressions “infants/young children fed exclusively with human breast milk”, “infants or young children exclusively breast fed”, “exclusive breast-fed infants or young children” and “breast-fed infants/young children” can be used interchangeably. They refer to infants or young children fed with a great majority (i.e. at least 90%, or at least 95%, or at least 99%) or all (100%) of nutrients and/or energy originating from human breast milk.

The expression “conventional nutritional composition” refers to standard synthetic nutritional compositions such as infant formula, follow-up milks or growing-up milks already found in the market.

The terms “microbial”, “microflora” and “microbiota” can be used interchangeably.

The expressions “microbiota in the gut”, “microbiota of the gut”, “gut microbiota” and “intestinal microbiota” can be used interchangeably.

The expression “gut microbiota dysbiosis” refers to microbial imbalance in the gut.

The expression “preventing and/or treating gut microbiota dysbiosis” encompasses one or several of the following:
preventing microbiota dysbiosis in the gut
treating microbiota dysbiosis in the gut
preventing and treating microbiota dysbiosis in the gut.

By the expressions “preventing” or “prevention”, it is meant avoiding that a physical state, a condition or their consequences occurs and/or decreasing its incidence (i.e. reduction of the frequency).

By the expressions “treating” or “treatment”, it is meant a decrease of the duration and/or of the severity of a physical state, a condition or their consequences (e.g. a decrease or elimination of symptoms of the condition).

By the expressions “LNFP-1 metabolizing Bifidobacterium” or “LNFP-1 metabolizing Bifidobacteria species” is defined as a Bifidobacterium species or a strain thereof possessing the capacity to hydrolyze alpha 1-2 bound fucose, respectively harbors an 1,2-α-L-fucosidase belonging to the glycoside hydrolase 95 (GH95, see Katayama et al., 2004, J. Bacteriol. 186, 4885-4893).

The prevention and/or the treatment of a physical state, a condition or their consequences can occur during the treatment (i.e. during the administration of the composition of the present invention, either immediately after the start of the administration or some time after, e.g. some days or weeks after the start). But it can also encompass the prevention and/or the treatment later in life. The term “later in life” encompasses the effect after the termination of the intervention or treatment. The effect “later in life” can be from 1 week to several months, or even years, for example from 2 to 4 weeks, from 2 to 6 weeks, from 2 to 8 weeks, from 1 to 6 months or from 2 to 12 months. Suitably, the effect “later in life” can be from 12 months to 12 years, such as from 2 years to 10 years, or from 4 years to 5 years, after the administration of the composition.

The term “prebiotic” means non-digestible carbohydrates that beneficially affect the host by selectively stimulating the growth and/or the activity of healthy bacteria such as bifidobacteria in the colon of humans (Gibson G R, Roberfroid M B. Dietary modulation of the human colonic microbiota: introducing the concept of prebiotics. J Nutr. 1995; 125:1401-12).

The term “probiotic” means microbial cell preparations or components of microbial cells with a beneficial effect on the health or well-being of the host. (Salminen S, Ouwehand A. Benno Y. et al. “Probiotics: how should they be defined” Trends Food Sci. Technol. 1999:10 107-10). The microbial cells are generally bacteria or yeasts.

The term “cfu” should be understood as colony-forming unit.

All percentages are by weight unless otherwise stated.

All weights expressed in g per 100 g of composition are dry weight unless otherwise stated. The term “SCFA” means short chain fatty acid(s). Short Chain fatty acids are especially produced by microbial fermentation of dietary fibres in the intestine.

The expression “increasing SCFA production” means that the amount of systemic and/or colonic SCFA, is higher in an individual fed with the nutritional composition according to the present invention in comparison with a standard. The SCFA production may be measured by techniques known by the skilled person such as by Gas-Liquid Chromatography.

The “Average Nucleotide Identity (ANI)” is a measure of nucleotide-level genomic similarity between the coding regions of two genomes. Average Nucleotide Identity can be assessed as describe here: Yoon S H, Ha S M, Lim J, Kwon S, Chun J. A large-scale evaluation of algorithms to calculate average nucleotide identity. Antonie Van Leeuwenhoek. 2017 October; 110(10):1281-1286. In the present embodiment the strain Bifidobacterium longum subsp. infantis LMG 11588 (also known as ATCC 17930) represents the reference genome to which a microbial genome is compared. An example of a microorganism genome that has at least 99.9% ANI with B. longum subsp. infantis LMG 11588 can be found in PATRIC (https://www.patricbrc.org), genome ID 1678.111. In one embodiment of the present invention, the Bifidobacterium longum subsp. infantis strain does not harbour potentially transferable antibiotic resistances.

The ANI of the shared genes between two strains is known to be a robust means to compare genetic relatedness among strains. Strains with ANI values of at least about 96% can be considered to belong to the same species (Konstantinidis and Tiedje, 2005, Proc Natl Acad Sci USA, 102(7):2567-72; and Goris et al., 2007, Int Syst Evol Microbiol. 57(Pt 1):81-91), while ANI values of at least about 99% indicate that the bacterial genomes belong to the same strain. The ANI between two bacterial genomes is calculated from pair-wise comparisons of all sequences shared between any two strains and can be determined, for example, using any of a number of publicly available ANI tools, including but not limited to OrthoANI with usearch (Yoon et al., 2017, Antonie van Leeuwenhoek 110:1281-1286); ANI Calculator, JSpecies (Richter and Rossello-Mora, 2009, Proc Natl Acad Sci USA 106:19126-19131); and JSpeciesWS (Richter et al., 2016, Bioinformatics 32:929-931). Other methods for determining the ANI of two genomes are known in the art (Konstantinidis, K. T. and Tiedje, 2005, J. M., Proc. Natl. Acad. Sci. U.S.A., 102: 2567-2572; and Varghese et al., 2015, Nucleic Acids Research, 43(14):6761-6771).

In addition, in the context of the invention, the terms “comprising” or “comprises” do not exclude other possible elements. The composition of the present invention, including the many embodiments described herein, can comprise, consist of, or consist essentially of the essential elements and limitations of the invention described herein, as well as any additional or optional ingredients, components, or limitations described herein or otherwise depending on the needs.

Any reference to prior art documents in this specification is not to be considered an admission that such prior art is widely known or forms part of the common general knowledge in the field.

The invention will now be described in further details. It is noted that the various aspects, features, examples and embodiments described in the present application may be compatible and/or combined together any combination thereof.

### Nutritional Composition

The present inventors have surprisingly found that the combination of LNFP-I and a galactose source having the structure of Formula I increases the production of ILA by a LNFP-1 metabolizing Bifidobacterium, for example Bifidobacterium longum subsp. infantis. That this specific combination increases the production of ILA by a LNFP-1 metabolizing Bifidobacterium, for example Bifidobacterium longum subsp. infantis is surprising, since the inventors have found that the combination of an alternative fucosylated HMO, namely 2′-FL, and a galactose source having the structure of Formula I does not lead to increased production of ILA by a LNFP-1 metabolizing Bifidobacterium, for example Bifidobacterium longum subsp. infantis as compared to the individual components.

Accordingly, in a first aspect, the invention provides a nutritional composition comprising lacto-N-fucopentaose-I (LNFP-I), a LNFP-1 metabolizing Bifidobacterium, for example Bifidobacterium longum subsp. infantis, and a galactose source, wherein the galactose source consists of a structure of Formula I.

In a further aspect, the invention provides a combination comprising or consisting of LNFP-I, a LNFP-1 metabolizing Bifidobacterium, for example Bifidobacterium longum subsp. Infantis, and a galactose source, wherein the galactose source consists of a structure of Formula I. Preferably, the combination consists of LNFP-I, a LNFP-1 metabolizing Bifidobacterium, for example Bifidobacterium longum subsp. infantis and a galactose source, wherein the galactose source consists of a structure of Formula I.

In some preferred embodiments, the LNFP-1 metabolizing Bifidobacterium is Bifidobacterium longum subsp. infantis.

Accordingly, in further aspect, the invention provides a nutritional composition comprising lacto-N-fucopentaose-I (LNFP-I), Bifidobacterium longum subsp. infantis, and a galactose source, wherein the galactose source consists of a structure of Formula I.

In a further aspect, the invention provides a combination comprising or consisting of LNFP-I, Bifidobacterium longum subsp. Infantis, and a galactose source, wherein the galactose source consists of a structure of Formula I. Preferably, the combination consists of LNFP-I, Bifidobacterium longum subsp. infantis and a galactose source, wherein the galactose source consists of a structure of Formula I.

Bifidobacterium longum is a bacterium of the Bifidobacterium genus which is present in the human gastrointestinal tract. In 2002, three previously distinct species of Bifidobacterium, B. infantis, B. longum, and B. suis, were unified into a single species named B. longum with the biotypes infantis, longum, and suis, respectively (Sakata, S., et al., 2002. International journal of systematic and evolutionary microbiology, 52(6), pp. 1945-1951).

Any suitable Bifidobacterium longum subsp. infantis strain may be used in the present invention. Such strains will be well-known to the skilled person. Suitable strains include Bifidobacterium longum subsp. infantis LMG 11588 (also known as Bifidobacterium longum subsp. infantis NCC3039 or Bifidobacterium longum subsp. infantis ATCC 17930) and Bifidobacterium longum subsp. infantis ATCC 15697 (also known as Bifidobacterium longum subsp. infantis NCC 3078), Rosell-33 (sold by Lallemand), m-63 (sold by Morinaga).

The Bifidobacterium longum subsp. infantis may be a strain having at least 99% (suitably, at least 99.9%) ANI to Bifidobacterium longum subsp. infantis strain known to the skilled person.

Suitably, the Bifidobacterium longum subsp. infantis has at least 99% (suitably, at least 99.1%, at least 99.2%, at least 99.3%, at least 99.4%, at least 99.5%, at least 99.6%, at least 99.7%, at least 99.8%, at least 99.9%) ANI to Bifidobacterium longum subsp. infantis LMG 11588 (also known as Bifidobacterium longum subsp. infantis NCC3039 or Bifidobacterium longum subsp. infantis ATCC 17930). Preferably, the Bifidobacterium longum subsp. infantis has at least 99.9% ANI to Bifidobacterium longum subsp. infantis LMG 11588.

Bifidobacterium longum subsp. infantis LMG 11588 is sold by the Belgian Coordinated Collections of Microorganisms (BCCM) under the LMG accession number LMG 11588.

Suitable LNFP-1 metabolizing Bifidobacteria species according to the present invention may be selected from the list consisting of: Bifidobacterium lactis, B. longum, Bifidobacterium breve, B. longum subsp. infantis, B. longum subsp. iuvenis, B. bifidum, B. pseudocatenulatum and B. kashiwanohense, and any combination thereof.

In one embodiment, the LNFP-1 metabolizing Bifidobacteria species is Bifidobacterium lactis. In one embodiment, the LNFP-1 metabolizing Bifidobacteria species is B. longum. In one embodiment, the LNFP-1 metabolizing Bifidobacteria species is Bifidobacterium breve. In one embodiment, the LNFP-1 metabolizing Bifidobacteria species is B. longum subsp. infantis. In one embodiment, the LNFP-1 metabolizing Bifidobacteria species is B. longum subsp. iuvenis. In one embodiment, the LNFP-1 metabolizing Bifidobacteria species is B. bifidum. In one embodiment, the LNFP-1 metabolizing Bifidobacteria species is B. pseudocatenulatum. In one embodiment, the LNFP-1 metabolizing Bifidobacteria species is B. kashiwanohense.

Suitable probiotic bacterial strains according to the present invention include Bifidobacterium animalis subsp. lactis CNCM 1-3446 deposited according to the Budapest Treaty on 7 Jun. 2005 at Collection Nationale Cultures De Microorganismes [French National Collection Of Microorganism Cultures](CNCM), Institut Pasteur, 25 Rue Du Docteur Roux, F-75724 Paris Cedex 15 (France), or BL818 or Bifidobacterium animalis subsp. lactis sold inter alia by the Christian Hansen company of Denmark under the trademark Bb 12, also known as DSM-15954, B. longum CNCM I-2618 (B. longum NCC2705), Bifidobacterium breve sold by Danisco under the trademark Bb-03, Bifidobacterium breve sold by Morinaga under the trade mark M-16V, Bifidobacterium breve sold by Morinaga under the trade mark B-3, Bifidobacterium breve sold by sold by Yakult under the trade mark BBG-01 and Bifidobacterium breve sold by Institut Rosell (Lallemand) under the trademark R0070.

In some preferred embodiments the Bifidobacterium longum subsp longum strain may be selected from Bifidobacterium longum subsp longum strain CNCM I-2169, Bifidobacterium longum subsp longum strain CNCM I-2171, Bifidobacterium longum subsp longum strain ATCC 15708, Bifidobacterium longum subsp longum strain DSM 20097, Bifidobacterium longum subsp longum strain NCIMB 8809, Bifidobacterium longum subsp longum strain CNCM I-2618 (NCC 2705), Bifidobacterium longum subsp longum strain CNCM I-2170, Bifidobacterium longum subsp longum strain ATCC 15707, or a combination thereof, in particular B. longum CNCM I-2618 (NCC 2705).

Suitably, the Bifidobacterium longum subsp. longum has at least 99% (suitably, at least 99.1%, at least 99.2%, at least 99.3%, at least 99.4%, at least 99.5%, at least 99.6%, at least 99.7%, at least 99.8%, at least 99.9%) ANI to Bifidobacterium longum subsp. longum NCC 2705 (also known as Bifidobacterium longum subsp. longum CNCM I-2618). Preferably, the Bifidobacterium longum subsp. longum has at least 99.9% ANI to Bifidobacterium longum subsp. longum NCC 2705.

B. longum NCC 2705 was deposited with the Institute Pasteur, 25 Rue Du Docteur Roux, F-75724 Paris Cedex 15 (France) according to the Budapest Treaty on 29 Jan. 2001 receiving the deposit no. CNCM I-2618.

Bifidobacterium longum subsp microorganisms of a clade that is present in the gut microbiome of the transitional feeding period of mammals, particularly humans, have previously been identified. B. longum microorganisms belonging to this clade are referred to herein as Bifidobacterium longum transitional (B. longum transitional) and are also known in the art as B. longum subsp. iuvenis (see Modesto et al; International Journal of Systematic and Evolutionary Microbiology 73(10)). B. longum transitional strains NCC 5000, NCC 5001, NCC 5002, NCC 5003 and NCC 5004 were deposited with the Collection nationale de cultures de micro-organisms (CNCM), Institute Pasteur (INSTITUT PASTEUR, 25 RUE DU DOCTEUR ROUX, F-75724 PARIS CEDEX 15, FRANCE) by SOCIETE DES PRODUITS NESTLE S.A according to Budapest Treaty on 11th of May 2021 receiving the deposit numbers CNCM I-5683, CNCM I-5684, CNCM I-5685, CNCM I-5686 and CNCM I-5687, respectively.

In some embodiments, a B. longum transitional microorganism has an ANI of at least 96% with at least one B. longum strain selected in the group consisting of CNCM I-5683, CNCM I-5684, CNCM I-5685, CNCM I-5686, CNCM I-5687, and CMCC-P0001 (ATCC BAA-2753), and any combination thereof. In some embodiments, a Bifidobacterium longum transitional microorganism has an ANI of about 96%, 96.1%, 96.2%, 96.3%, 96.4%, 96.5%, 96.6%, 96.7%, 96.8%, 96.9%, 97%, 97.1%, 97.2%, 97.3%, 97.4%, 97.5%, 97.6%, 97.7%, 97.8%, 97.9%, 98%, 98.1%, 98.2%, 98.3%, 98.4%, 98.5%, 98.6%, 98.6%, 98.7%, 98.8%, 98.9%, 99%, 99.1%, 99.2%, 99.3%, 99.4%, 99.5%, 99.6%, 99.7%, 99.8%, 99.9%, or 100% with at least one Bifidobacterium longum strain selected in the group consisting of CNCM I-5683, CNCM I-5684, CNCM I-5685, CNCM I-5686, CNCM I-5687 and CMCC-P0001 (ATCC BAA-2753), and any combination thereof. In some embodiments, a Bifidobacterium longum transitional microorganism has an ANI of at least 96%, of at least 96.1%, of at least 96.2%, of at least 96.3%, of at least 96.4%, of at least 96.5%, of at least 96.6%, of at least 96.7%, of at least 96.8%, of at least 96.9%, of at least 97%, of at least 97.1%, of at least 97.2%, of at least 97.3%, of at least 97.4%, of at least 97.5%, of at least 97.6%, of at least 97.7%, of at least 97.8%, of at least 97.9%, of at least 98%, of at least 98.1%, of at least 98.2%, of at least 98.3%, of at least 98.4%, of at least 98.5%, of at least 98.6%, of at least 98.6%, of at least 98.7%, of at least 98.8%, of at least 98.9%, of at least 99%, of at least 99.1%, of at least 99.2%, of at least 99.3%, of at least 99.4%, of at least 99.5%, of at least 99.6%, of at least 99.7%, of at least 99.8%, of at least 99.9% with at least one Bifidobacterium longum strain selected in the group consisting of CNCM I-5683, CNCM I-5684, CNCM I-5685, CNCM I-5686, CNCM I-5687 and CMCC-P0001 (ATCC BAA-2753), and any combination thereof.

In some embodiments, a B. longum transitional microorganism has an Average Nucleotide Identity (ANI) of at least 98% with at least one B. longum strain selected in the group consisting of CNCM I-5683, CNCM I-5684, CNCM I-5685, CNCM I-5686 and CNCM I-5687, and any combination thereof. In some embodiments, a B. longum transitional microorganism has an ANI of about 98% to 100% with at least one B. longum strain selected in the group consisting of CNCM I-5683, CNCM I-5684, CNCM I-5685, CNCM I-5686 and CNCM I-5687, and any combination thereof. In some embodiments, a B. longum transitional microorganism has an ANI of at least 98%, 98.1%, 98.2%, 98.3%, 98.4%, 98.5%, 98.6%, 98.6%, 98.7%, 98.8%, 98.9%, 99%, 99.1%, 99.2%, 99.3%, 99.4%, 99.5%, 99.6%, 99.7%, 99.8%, 99.9%, or 100% with at least one B. longum strain selected in the group consisting of CNCM I-5683, CNCM I-5684, CNCM I-5685, CNCM I-5686 and CNCM I-5687, and any combination thereof.

In some embodiments, a B. longum transitional microorganism has an ANI of at least 98.6%, of at least 98.6%, of at least 98.7%, of at least 98.8%, of at least 98.9%, of at least 99%, of at least 99.1%, of at least 99.2%, of at least 99.3%, of at least 99.4%, of at least 99.5%, of at least 99.6%, of at least 99.7%, of at least 99.8%, of at least 99.9% or of at least 100% with at least one B. longum strain selected in the group consisting of CNCM I-5683, CNCM I-5684, CNCM I-5685, CNCM I-5686 and CNCM I-5687, and any combination thereof.

The GenBank (EMBL) accession numbers for the 16S rRNA gene sequence and genome of Bifidobacterium longum subsp. iuvenis NCC 5000T are OP696622 (GenBank) and Ga0527908 (JGI), respectively.

In some embodiments, a B. longum iuvenis microorganism for use in the present invention has an ANI of at least 98%, 98.1%, 98.2%, 98.3%, 98.4%, 98.5%, 98.6%, 98.6%, 98.7%, 98.8%, 98.9%, 99%, 99.1%, 99.2%, 99.3%, 99.4%, 99.5%, 99.6%, 99.7%, 99.8%, 99.9%, or 100% compared to B. longum iuvenis NCC 5000. In some embodiments, a B. longum iuvenis microorganism for use in the present invention has an ANI of at least 98.6%, of at least 98.6%, of at least 98.7%, of at least 98.8%, of at least 98.9%, of at least 99%, of at least 99.1%, of at least 99.2%, of at least 99.3%, of at least 99.4%, of at least 99.5%, of at least 99.6%, of at least 99.7%, of at least 99.8%, of at least 99.9% or of at least 100% compared to B. longum iuvenis NCC 5000.

B. longum subsp. iuvenis strain NCC 5025 was deposited with the Collection Nationale de Cultures de Micro-organisms (CNCM), Institute Pasteur by SOCIÉTÉ DES PRODUITS NESTLÉ S.A according to Budapest Treaty on the 29 Mar. 2023 receiving the deposit number CNCM I-5942.

In some embodiments, the Bifidobacterium longum transitional microorganism for use according to the invention has an Average Nucleotide Identity (ANI) of at least 98% with the B. longum transitional strain deposited under deposit number CNCM I-5942.

Suitably, the Bifidobacterium longum transitional microorganism for use according to the invention has an Average Nucleotide Identity (ANI) of at least 98% with CNCM I-5942.

Suitably, the B. longum transitional strain has an ANI of at least 98.1%, at least 98.2%, at least 98.3%, at least 98.4%, of at least 98.5%, of at least 98.6%, of at least 98.6%, of at least 98.7%, of at least 98.8%, of at least 98.9%, of at least 99%, of at least 99.1%, of at least 99.2%, of at least 99.3%, of at least 99.4%, of at least 99.5%, of at least 99.6%, of at least 99.7%, of at least 99.8%, or of at least 99.9% compared to the B. longum strain deposited with the CNCM under deposit number CNCM I-5942.

In some embodiments, the B. longum transitional strain has an ANI of at least at least 99.0%, at least 99.1%, at least 99.2%, at least 99.3%, at least 99.4%, at least 99.5%, at least 99.6%, at least 99.7%, at least 99.8%, or at least 99.9%, compared to the B. longum strain deposited with the CNCM under deposit number CNCM I-5942.

Preferably, the B. longum transitional strain has an ANI of at least 99.9% compared to the B. longum strain deposited with the CNCM under deposit number CNCM I-5942.

Suitably, the B. longum subsp. iuvenis may be B. longum subsp. iuvenis NCC 5025. Suitably, the B. longum transitional microorganism may be a Bifidobacterium longum transitional microorganism strain deposited with CNCM under deposit number CNCM I-5942.

Methods for sequencing microbial genomes are well known in the art (see e.g. Segerman; Front. Cell. Infect. Microbiol.; 2020; 10; Article 527102 & Donkor; Genes; 2013; 4(4); 556-572).

By way of example, metagenomics methods may be used. Suitable metagenomics methods may be performed using shotgun sequencing data, for example. Suitable metogenomics methods are known in the art and include MetaPhlAn 3.0, for example (see Beghini et al.; eLife 2021; 10: e65088; https://huttenhower.sph.harvard.edu/metaphlan).

Genome sequences for B. longum transitional strains NCC 5000 (CNCM I-5683), NCC 5001 (CNCM I-5684), NCC 5002 (CNCM I-5685), NCC 5003 (CNCM I-5686) and NCC 5004 (CNCM I-5687) are available via Joint Genome Project (JGI) Study number: Gs0156595 (https://genome.igi.doe.gov/portal/). Analysis project numbers and taxon numbers for each genome are as follows:

| Strain | JGI analysis project | JGI taxon |
|---|---|---|
| B. longum NCC 5000 | Ga0527908 | 2951181949 |
| B. longum NCC 5001 | Ga0529016 | 2951184202 |
| B. longum NCC 5002 | Ga0529017 | 2951186501 |
| B. longum NCC 5003 | Ga0529018 | 2951188792 |
| B. longum NCC 5004 | Ga0529019 | 2951191018 |

In some embodiments, the B. longum transitional microorganism for use in the present invention is isolated from a human.

The nutritional composition according to the invention may contain from 10³ to 10¹² cfu of a LNFP-1 metabolizing Bifidobacterium, for example Bifidobacterium longum subsp. infantis, more preferably between 10⁷ and 10¹² cfu such as between 10⁸ and 10¹⁰ cfu of a LNFP-1 metabolizing Bifidobacterium, for example Bifidobacterium longum subsp. infantis, per g of composition on a dry weight basis. Suitably, the LNFP-1 metabolizing Bifidobacterium, for example the Bifidobacterium longum subsp. infantis, is administered to the subject in an amount of at least about 10⁶ cfu/day, at least about 10⁷ cfu/day, or at least about 10⁸ cfu/day. Suitably, the LNFP-1 metabolizing Bifidobacterium, for example the Bifidobacterium longum subsp. infantis, is administered to the subject in an amount of about 10¹² cfu/day or less, about 10¹¹ cfu/day or less, or about 10¹⁰ cfu/day or less.

In one embodiment, the LNFP-1 metabolizing Bifidobacterium, for example Bifidobacterium longum subsp. infantis, is viable.

In some embodiments, LNFP-I is present in a total amount of from 25 mg/L to 5000 mg/L of the nutritional composition or combination according to the invention or of from 0.02 g/100 g to 4 g/100 g of the nutritional composition or combination according to the invention. Suitably, LNFP-I is present in a total amount of from 50 mg/L to 2500 mg/L, for example from 60 mg/L to 2000 mg/L, for example from 80 mg/L to 1000 mg/L of the nutritional composition or combination according to the invention. Suitably, LNFP-I is present in a total amount of from 0.04 g/100 g to 2 g/100 g, for example from 0.05 g/100 g to 1.6 g/100 g, for example from 0.07 g/100 g to 0.8 g/100 g of the nutritional composition or combination (dry weight).

LNFP-I may be isolated by chromatography or filtration technology from a natural source such as animal milks. Suitably, the animal milk as used herein may be cow, sheep, goat, camel or buffalo milk. Preferably, the animal milk is cow's milk. Preferably, the LNFP-I may be produced by biotechnological means using specific fucosyltransferases and/or fucosidases either through the use of enzyme-based fermentation technology (recombinant or natural enzymes) or microbial fermentation technology. In the latter case, microbes may either express their natural enzymes and substrates or may be engineered to produce respective substrates and enzymes. Single microbial cultures and/or mixed cultures may be used. Fucosylated oligosaccharide formation can be initiated by acceptor substrates starting from any degree of polymerization (DP), from DP=1 onwards. Suitable techniques for producing LNFP-I are known in the art (see, for example, Hu et al., Carbohydr Polym, 2022, 297: 120017 and Derya et al., J Biotechnol., 2020, 318: 31-38). Alternatively, LNFP-I may be produced by chemical synthesis from lactose as initial acceptor substrate building an LNT backbone and free fucose as final donor substrate or by starting from LNT for example, produced by biotechnology or chemical synthesis, and using fucose. Fucosylated oligosaccharides are also available for example from DSM of the Netherlands or from Elicityl of France.

### Galactose Source

Polymers of galactose are a highly-metabolisable prebiotic substrate for probiotics and beneficial commensals, such as a LNFP-1 metabolizing Bifidobacterium, for example Bifidobacterium longum subsp. infantis, in the gastrointestinal tract (Wilson and Whelan, 2017, Journal of Gastroenterology and Hepatology, 32(Suppl. 1): 64-68; and Roberfroid et al., 2010, British Journal of Nutrition, 104(S2): S1-S63). Thus, the composition and combination of the invention contain a source of galactose.

The galactose source according to the invention consists of a structure of Formula I.

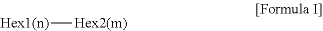

wherein:
Hex1 is galactose,
Hex2 is galactose or glucose,

$$n = 1 - 9 , and$$

$$m = 1.$$

Suitably, Hex1 may be a derivative of galactose. For example, Hex2 may be an amino sugar derivative of galactose such as N-Acetylgalactosamine (GalNAc).

Galacto-oligosaccharides (GOS) are defined as polymers of galactose (minimum 2 galactose monomers) with a terminal β-linked galactose or glucose monomer. GOS is a commonly-added prebiotic substrate in infant formula compositions, for example as commercially available in the form of Vivinal-GOS (sold by Friesland Campina of the Netherlands), or in the form of Bovine Milk-derived Oligosaccharides (BMOS) (Estorninos et al., Am J Clin Nutr., 2022, 115: 142-153). BMOS in particular promote the selective growth Bifidobacterium species such as Bifidobacterium longum subsp. infantis (Roberfroid et al., 2010, British Journal of Nutrition, 104(S2): S1-S63).

In some embodiments, the galactose source is selected from galacto-oligosaccharides (GOS), Bovine Milk-derived Oligosaccharides (BMOS) and combinations thereof.

In a particular embodiment, the nutritional composition according to the invention can comprise GOS. A galacto-oligosaccharide is an oligosaccharide comprising two or more galactose molecules. Suitable galacto-oligosaccharides that may also be added in the nutritional composition according to the present invention include Galβ1,3Galβ1,4Glc, Galβ1,6Galβ1,4Glc, Galβ1,3Galβ1,3Galβ1,4Glc, Galβ1,6Galβ1,6Galβ1,4Glc, Galβ1,3Galβ1,6Galβ1,4Glc, Galβ1,6Galβ1,3Galβ1,4Glc, Galβ1,6Galβ1,6Galβ1,6Glc, Galβ1,3Galβ1,3Glc, Galβ1,4Galβ1,4Glc and Galβ1,4Galβ1,4Galβ1,4Glc but also any mixture thereof.

Oligosaccharides occur naturally in the milk of some mammals, e.g., cow, sheep, goat, buffalo, camel and human. GOS are commercially available and can be synthesized via biosynthesis processes from lactose by transgalactosidase activity of β-galactosidases (degree of polymerization 2-8). GOS formation in biosynthesis procedures is usually favored by high concentrations of lactose or lactulose, incomplete lactose turnover, low water activity, and the use of enzymes with preference for trans-galactosylation. The linkage type(s) of resulting GOS from such processes is(are) specific for the enzymes used for biosynthesis.

Synthesized galacto-oligosaccharides such as Galβ1,6Galβ1,4Glc, Galβ1,6Galβ1,6Galβ1,6Glc, Galβ1,3Galβ1,4Glc, Galβ1,6Galβ1,6Galβ1,4Glc, Galβ1,6Galβ1,3Galβ1,4Glc, Galβ1,3Galβ1,6Galβ1,4Glc, Galβ1,4Galβ1,4Glc and Galβ1,4Galβ1,4Galβ1,4Glc and mixture thereof are commercially available under trademarks Vivinal® and Elix'or®. Other suppliers of oligosaccharides are Dextra Laboratories, Sigma-Aldrich Chemie GmbH and Kyowa Hakko Kogyo Co., Ltd. Alternatively, specific glycosyltransferases, such as galactosyltransferases may be used to produce neutral oligosaccharides.

Moreover, such GOS may be comprised in the inventive composition in an amount of at least 1 or 2 g per daily dose, preferably at least 3 g per daily dose, likewise preferably between 2 to 12 g per daily dose, or between 2 to 10 g per daily dose, between 2 to 8 g per daily dose, or between 2 to 7 g per daily dose, more preferably between 3 to 12 g per daily dose, likewise more preferably between 5 and 10 g per daily dose, such as between 5 to 8 g per daily dose, between 5 to 7 g per daily dose, between 5 to 6 g per daily dose, or about 2, 3, 4, 5, 6, 7, 8, 9, 10, 11, or 12 g per daily dose or any range formed thereby. In a preferred embodiment, GOS may be comprised in the composition in an amount of from about 5 to about 7 g per daily dose.

In a particular embodiment, the nutritional composition according to the invention can comprise BMOS. BMOS may be oligosaccharide preparations derived from bovine milk and/or whey fractions. One route to increasing oligosaccharides in bovine milk derived fractions is to transform part of the lactose in such fractions to GOS. BMOS can typically be obtained from concentrating whey permeate to obtain a concentrated bovine milk oligosaccharide composition and either adding GOS or generating the GOS in situ from hydrolysis of lactose by the action of a β-galactosidase (Duncan et al., Nutrients, 2020, 12: 2007).

One particular type of mixture of carbohydrates that can advantageously be used herein as a source of GOS is a mixture of GOS and of BMOS. Indeed, such mixtures contain some oligosaccharides similar to human milk, which is particularly advantageous when the composition of the invention is used as an infant formula or as a nutritional supplement for infants. Such advantageous effects are described for example in Simeoni et al. (Simeoni et al., Environ Microbiol, 2016, 18(7): 2185-2195). Mixtures of BMOS and GOS can be prepared as described above, whereby GOS are added to or generated in situ within a concentrated bovine milk oligosaccharide composition.

The GOS source can be provided in the form of essentially pure GOS (i.e., ingredient having at least 90% GOS) or as part of a mixture, such as a mixture of carbohydrates, comprising GOS. The essential aspect is that a sufficient amount of GOS is provided in the composition. According to one embodiment, the GOS source is therefore typically added to the composition in an amount of at least 0.2 wt %, preferably at least 0.5 wt %, even more preferably at least 0.75 wt % of GOS, and preferably at most 8 wt % of GOS, such as at most 7 wt % GOS, at most 6 wt % GOS, or even at most 5 wt % GOS, more preferably at most 4 wt % of GOS or even at most 3% GOS, at most 2 wt % of GOS, or at most 1 wt % of GOS. More preferably, GOS is added to the composition in a range of 0.2 wt % to 8 wt % or even 0.2 wt % to 7 wt %, or 0.2 wt % to 6 wt %, more preferably in a range of 0.5 wt % to 8 wt % or even 0.5 wt % to 7 wt %, or 0.5 wt % to 6 wt %, even more preferably in a range of 0.75 wt % to 8 wt % or even 0.75 wt % to 7 wt %, or 0.75 wt % to 6 wt %, and most preferably in a range of 0.75 wt % to 7 wt %, in a range of 0.75 wt % to 6 wt % or even in a range of 0.75 wt % to 5 wt %, such as a range of 0.75 wt % to 3 wt % or 0.75 wt % to 4 wt %, preferably calculated % w/w).

When a mixture of carbohydrates is used as a source of GOS, it is preferred that the amount of GOS in such a mixture is at least 20 wt %, preferably at least 30 wt %, more preferably at least 40 wt %, even more preferably at least 45 wt %, most preferably at least 48 wt %, preferably calculated on a dry weight basis of the mixture containing GOS. Although it is not necessary that the bacteria consume only GOS as carbon source, a high proportion of GOS in the GOS source, favours the consumption of GOS by the bacteria over consumption of other carbohydrates. Smaller carbohydrates such as di-saccharides (lactose for instance) can also be present. Accordingly, it is also preferred that the GOS source comprises at most 55 wt %, preferably at most 50 wt %, more preferably at most 45 wt %, most preferably at most 42 wt % of mono- or di-saccharides and/or no more than 40 wt %, preferably no more than 30 wt % lactose, preferably calculated on a dry weight basis of the mixture containing GOS. As an example, a mixture of carbohydrate used as a source of GOS may comprise GOS in amounts defined above for the mixture and the remainder formed by lactose, glucose, and/or galactose.

In a particular embodiment, the nutritional composition can also contain at least one bovine milk oligosaccharide. Conventional technologies for fractioning and enriching bovine milk fractions in bovine milk derived oligosaccharides can be used (such conventional technologies include column filtration, resin-filtration, nano-filtration, enzymatic treatment specially with beta-galactosidase, precipitation of proteins, crystallisation and separation of lactose, etc.). Some fractions of bovine milk enriched in oligosaccharides are commercially available or have been described, for example in EP2526784 A1.

In a particular embodiment, the nutritional composition may also additionally comprise an oligosaccharide mixture (“BMOS”) that comprises from 0.1 to 4.0 wt % of N-acetylated oligosaccharide(s), from 92.0 to 98.5 wt % of the galacto-oligosaccharide(s) and from 0.1 to 4.0 wt % of the sialylated oligosaccharide(s).

### Protein Source

In some preferred embodiments of the invention, the composition further comprises a protein source. Suitably, the protein source has an optimized aminogram, for example enrichment in aromatic amino acids, an adapted protein profile, for example by mixing with casein, and/or adapted peptide profile for metabolic accessibility by Bifidobacterium species, for example by partial hydrolysis.

As used herein, the term “protein source” refers to a source of amino acids. Thus, the protein source comprises amino acids. Suitably, the protein source may comprise amino acids (e.g. free amino acids) or a salt thereof, oligopeptides, peptides, proteins, amino acid precursors or any combination thereof. Preferably, the protein source may comprise oligopeptides, peptides, proteins, or any combination thereof. More preferably, the protein source may comprise partially hydrolysed or hydrolysed oligopeptides, peptides, proteins, or any combination thereof.

As used herein, the term “free amino acids” may refer to amino acid monomers, which are not part of an oligopeptide, peptide, or protein. Amino acid salts may include any physiologically acceptable salt, such as hydrochloride, sodium, potassium, calcium, and magnesium salts. Preferably, the salt is a sodium or potassium salt. Preferably, the free amino acids are aromatic amino acid monomers, such as tryptophan, tyrosine, phenylalanine or any combination thereof. Most preferably, the free amino acid is tryptophan monomer.

As used herein, the term “oligopeptides” may refer to short chains of amino acid monomers (e.g. 2 to 20 amino acid monomers) linked via peptide bonds and can include dipeptides, tripeptides, tetrapeptides, and pentapeptides. The oligopeptides may be enriched for one or more amino acids or consist solely of a single type of amino acid. Suitably, the oligopeptides may be enriched for one or more aromatic amino acids or consist solely of a single type of aromatic amino acid. Preferably, the aromatic amino acids are selected from tryptophan, tyrosine, phenylalanine or any combination thereof. Most preferably, the aromatic amino acid is tryptophan.

As used herein, the term “peptides” may refer to short chains of amino acid monomers (e.g. 20 to 50 amino acid monomers) linked via peptide bonds. The peptides may be enriched for one or more amino acids or consist solely of a single type of amino acid. Suitably, the peptides may be enriched for one or more aromatic amino acids or consist solely of a single type of aromatic amino acid. Preferably, the aromatic amino acids are selected from tryptophan, tyrosine, phenylalanine or any combination thereof. Most preferably, the aromatic amino acid is tryptophan.

The terms “polypeptide” and “protein” are used herein interchangeably. As used herein, the terms “polypeptides” and “proteins” may refer to long chains of amino acids (e.g. greater than about 50 amino acids). The amino acids may be, partially, or entirely, in the form of proteins. The polypeptides or proteins may be enriched for one or more amino acids or consist solely of a single type of amino acid. Suitably, the polypeptides or proteins may be enriched for one or more aromatic amino acids or consist solely of a single type of aromatic amino acid. Preferably, the aromatic amino acids are selected from tryptophan, tyrosine, phenylalanine or any combination thereof. Most preferably, the aromatic amino acid is tryptophan.

Suitably, the protein source has an optimized aminogram, i.e. the amino acid profile of the protein source has been changed to the desired profile. For example, the protein source may be enriched in aromatic amino acids. By way of further example, the protein source may consist of aromatic amino acids. Preferably, the aromatic amino acids are selected from tryptophan, tyrosine, phenylalanine or any combination thereof. Most preferably, the aromatic amino acid is tryptophan.

Suitably, the protein source has an adapted protein profile and/or an adapted peptide profile for metabolic accessibility by Bifidobacterium species. Thus, the protein source may have a structure or composition which avoids digestion of the amino acids by the subject and promotes availability of the amino acids for fermentation by Bifidobacterium species in the large intestine and/or colon of the subject.

In some embodiments, the protein source has an adapted protein profile.

In some embodiments, the protein source has an adapted peptide profile.

The term “adapted protein profile” may refer to the adaptation of the components provided in the protein source, i.e. to adapting the particular oligopeptide, peptide and/or protein components provided in the protein source. The term “adapted peptide profile” may refer to the adaptation of the size distribution of the oligopeptides, peptides and proteins. For example, the peptide profile of the protein source may be adapted by partial hydrolysis and/or the protein profile of the protein source may be adapted by mixing with casein. The present inventors have surprisingly found that partial hydrolysis of the protein source increases availability of the amino acids for fermentation by Bifidobacterium species (see Example). It is known that embedding factors, for example transforming growth factor beta (TGF-β), within casein protects TGF-β from digestion by the subject (e.g. by the upper gastrointestinal tract of the subject) such that TGF-β can exert its effects in the large intestine. Hence, embedding aromatic amino acids within casein would be expected to avoid digestion of the amino acids by the subject and promote availability of the amino acids for fermentation by Bifidobacterium species in the large intestine and/or colon of the subject.

In some embodiments, the protein source has an optimised aminogram and an adapted protein profile.

In some embodiments, the protein source has an optimised aminogram and an adapted peptide profile.

In some embodiments, the protein source has an optimised aminogram, and an adapted protein profile and an adapted peptide profile.

The protein can be in an amount of from 1.4 to 3 g per 100 kcal. In some embodiments, especially when the composition is intended for premature infants, the protein amount can be between 2.4 and 4 g/100 kcal or more than 3.6 g/100 kcal. In some other embodiments, the protein amount can be below 2.0 g per 100 kcal, e.g. between 1.8 to 2 g/100 kcal, or in an amount below 1.8 g per 100 kcal, such as between 1.4 to 1.8 g protein/100 kcal.

### Degree of Hydrolysis of the Protein Source

The proteins may be intact or hydrolysed or a mixture of intact and hydrolysed proteins. By the term “intact” is meant that the main part of the proteins are intact, i.e. the molecular structure is not altered, for example at least 80% of the proteins are not altered, such as at least 85% of the proteins are not altered, preferably at least 90% of the proteins are not altered, even more preferably at least 95% of the proteins are not altered, such as at least 98% of the proteins are not altered. In a particular embodiment, 100% of the proteins are not altered.

The term “hydrolysed” means in the context of the present invention an oligopeptide, peptide or protein which has been hydrolysed or broken down into its component amino acids. The oligopeptides, peptides or proteins may be either fully or partially hydrolysed. It may be desirable to supply partially hydrolysed oligopeptides, peptides or proteins (degree of hydrolysis between 2 and 20%), for example for infants or young children believed to be at risk of developing cow's milk allergy. If hydrolysed oligopeptides, peptides or proteins are required, the hydrolysis process may be carried out as desired and as is known in the art. For example, whey protein hydrolysates may be prepared by enzymatically hydrolysing the whey fraction in one or more steps. In some embodiments, the enzyme is a trypsin preparation. In some embodiments, the enzyme is porcine trypsin. In some embodiments, the enzymes are trypsin like or chymotrypsin like enzymes.

In one particular embodiment the proteins of the nutritional composition are hydrolysed, fully hydrolysed or partially hydrolysed. The degree of hydrolysis (DH) of the protein can be between 8 and 40, or between 20 and 60 or between 20 and 80 or more than 10, 20, 40, 60, 80 or 90.

In one particular embodiment the proteins of the nutritional composition are hydrolysed or partially hydrolysed. The average molecular weight is 190 to 2500 Da, preferably 600 to 2000 Da, more preferably 800 to 1500 Da, even more preferably 1000 to 1400 Da, for example 1100 to 1200 Da.

In an embodiment of the invention, at least 70% of the oligopeptides, peptides or proteins are hydrolysed, preferably at least 80% of the oligopeptides, peptides or proteins are hydrolysed, such as at least 85% of the oligopeptides, peptides or proteins are hydrolysed, even more preferably at least 90% of the oligopeptides, peptides or proteins are hydrolysed, such as at least 95% of the oligopeptides, peptides or proteins are hydrolysed, particularly at least 98% of the oligopeptides, peptides or proteins are hydrolysed. In a particular embodiment, 100% of the oligopeptides, peptides or proteins are hydrolysed.

Accordingly, suitable protein sources for use according to the invention include an intact protein source and a partially hydrolysed protein source.

Protein sources for use according to the invention may be animal milk, prepared from an animal milk or an animal milk fraction comprising free amino acids, oligopeptides, peptides or proteins.

Protein sources based on whey, casein and mixtures thereof may be used. As far as whey proteins are concerned, the protein source may be based on acid whey or sweet whey or mixtures thereof and may include alpha-lactalbumin and beta-lactoglobulin in any desired proportions. Protein sources of bovine, buffalo, goat and sheep origin, or mixtures thereof, may be used. For example, milk protein sources originating from different species may be mixed to provide the desired casein:whey ratio. By way of further example, milk protein sources originating from different species may be mixed to provide the desired aminogram and/or bifidobacteria accessible peptide profile. Suitably, the desired aminogram may be one enriched in aromatic amino acids. Preferably, the aromatic amino acids are selected from tryptophan, tyrosine, phenylalanine or any combination thereof. Most preferably, the aromatic amino acids is tryptophan.

The milk can be used as such (i.e. powder or liquid) as an ingredient, or these milk sources can be split into casein and whey according to the required application.

Caseins in the form of caseinates (Na, K, Ca), or in the form of micellar caseins originating from microfiltration processes may be used. Any suitable techniques which are known in the art for the preparation of such caseinates or micellar caseins may be used (see, for example, Carter et al., J Dairy Sci., 2021, 104:2465-2479).

Whey proteins are typically obtained through processing of an animal milk. For example, sweet whey may be obtained by rennet coagulation of milk, acid whey may be obtained by acid precipitation from milk, and native whey may be obtained by microfiltration of milk. Via various unit operations (such as nanofiltration, ultrafiltration, electrodialysis, ion exchange and any combination thereof), a wide range of whey ingredients can be obtained with various demineralisation degrees, protein contents and nutritional qualities in respect to amino acid profiles as desired.

Whey proteins in the form of sweet whey, acid whey and native whey, or any derivatives thereof obtained after processing as described herein, may be used.

Suitably, the sweet whey material for use according to the invention can be one of sweet whey obtained after separation of casein coagulated with rennet, a concentrate of sweet whey, a demineralized sweet whey, a demineralized concentrate of sweet whey, a concentrate of proteins of substantially lactose-free sweet whey obtained by ultrafiltration followed by diafiltration (ultrafiltration with washing), mother liquors of the crystallization of lactose from sweet whey, a permeate of ultrafiltration of a sweet whey, the product of hydrolysis—by a protease—of a native casein obtained by acid precipitation of skimmed milk with an inorganic acid or by biological acidification, obtained by microfiltration of a skimmed milk, or the product of hydrolysis of a caseinate by a protease. Preferably, the sweet whey has a solid content of about 6 to 30 wt. %. Suitably, the sweet whey has a solid content of about 6 to 30 wt. % after its decationisation. Suitably, sweet whey or a sweet whey protein concentrate may be further demineralized by electrodialysis, ion exchange, reverse osmosis, electrodeionisation or a combination of these procedures or other demineralization procedures known in the field (e.g. ultra- and/or nanofiltration).

Suitably, the range of the protein content in the sweet whey for use according to the invention is between 5 and 90 wt. %, such as between 10 and 80 wt. %, or between 20 and 70 wt. %, or between 30 and 60 wt. %, or between 40 and 50 wt. %, such as 11.5 wt. %.

Suitably, the acid whey material for use according to the invention can be one of acid whey obtained after separation of casein coagulated with acid, a concentrate of acid whey, a demineralized acid whey, a demineralized concentrate of acid whey, a concentrate of proteins of substantially lactose-free acid whey obtained by ultrafiltration followed by diafiltration (ultrafiltration with washing), mother liquors of the crystallization of lactose from acid whey, a permeate of ultrafiltration of an acid whey, the product of hydrolysis—by a protease—of a native casein obtained by acid precipitation of skimmed milk with an inorganic acid or by biological acidification, obtained by microfiltration of a skimmed milk, or the product of hydrolysis of a caseinate by a protease. Preferably, the acid whey has a solid content of about 6 to 30 wt. %. Suitably, the acid whey has a solid content of about 6 to 30 wt. % after its decationisation. Suitably, acid whey or an acid whey protein concentrate may be further demineralized by electrodialysis, ion exchange, reverse osmosis, electrodeionisation or a combination of these procedures or other demineralization procedures known in the field (e.g. ultra- and/or nanofiltration).

Suitably, the range of the protein content in the acid whey or native whey for use according to the invention is between 5 and 90 wt. %, such as between 10 and 80 wt. %, or between 20 and 70 wt. %, or between 30 and 60 wt. %, or between 40 and 50 wt. %, such as 11.5 wt. %.

Casein glycomacropeptide or caseinoglycomacropeptide (CGMP) can be extracted from a dairy source such as sweet whey. Any suitable method known in the art for the extraction of CGMP from a dairy source such as sweet whey may be used in the practice of the present invention. For example, the method disclosed in WO2016/128254 A1 may be used. Examples 1-4 of WO2016/128254 A1 are thereby incorporated by reference.

CGMP is a phosphorylated and partially sialylated macropeptide which is formed by the action of a protease, for example rennet, on mammalian milk kappa-casein. CGMP represents about 15 to 20% by weight of the proteins in sweet whey obtained after separation of casein during cheese manufacture.

A whey material (such as sweet whey) containing CGMP may be subjected to the extraction of CGMP. Suitably, a whey material (such as sweet whey) containing CGMP may be subjected to the extraction of CGMP to provide a protein material having a targeted tryptophan/threonine ratio, for example as described in EP 0 986 312 1, EP 3 256 001 1 or EP 3 255 999 E1. The resulting protein material following the extraction of CGMP from the starting whey material may be referred to as CGMP-reduced (acid, native or sweet) whey. Advantageously, the treated liquid material that is obtained from the extraction of CGMP from a whey material (such as sweet whey) has an amino acid profile which is enriched in aromatic amino acids such as Tryptophan (Trp) and reduced in Threonine (Thr). Suitably, a CGMP-reduced whey comprises at least an 85% reduction in the amount of CGMP compared to the starting whey material.

Suitably, the range of the protein content in the modified sweet whey (CGMP-reduced sweet whey) for use according to the invention is between 5 and 95 wt. %, between 10 and 80 wt. %, or between 20 and 70 wt. %, or between 30 and 60 wt. %, or between 40 and 50 wt. %, preferably 10 wt. %.

Alpha-lactalbumin enriched whey protein concentrate can be obtained, for example, by partial or complete removal of other major proteins like beta-lactoglobulin from milk. This leads to an increased ratio between alpha-lactalbumin and beta-lactoglobulin compared to the starting material, e.g. milk. Any suitable process for the preparation of alpha-lactalbumin enriched whey protein concentrate which is known in the art may be used.

Preferred protein sources for use according to the invention which have an optimised aminogram, an adapted protein profile and/or an adapted peptide profile include:
a) skimmed milk and demineralized, casein glycomacropeptide (CGMP)-reduced sweet whey;
b) skimmed milk and CGMP-free acid or native whey;
c) CGMP-free whey protein isolate and sweet whey protein concentrate;
d) demineralized CGMP-reduced sweet whey and demineralized sweet whey; and
e) skimmed milk and alpha-lactalbumin-enriched whey protein.

In some embodiments skimmed milk in a) is optional.

In some embodiments in b) sweet whey is used instead of native whey.

In some embodiments in b) sweet whey is CGMP-reduced.

In some embodiments in b) sweet whey protein concentrate is CGMP-reduced.

In some embodiments whey protein isolate in c) is CGMP-reduced.

In some embodiments the mixture of CGMP-free whey protein isolate and sweet whey protein concentrate in c) is partially or fully hydrolysed. Suitably, the mixture of CGMP-free whey protein isolate and sweet whey protein concentrate in c) is partially hydrolysed. Suitably, the mixture of CGMP-free whey protein isolate and sweet whey protein concentrate in c) is fully hydrolysed.

In some embodiments sweet whey in d) is not demineralized.

Hence, preferred protein sources for use according to the invention which have an optimised aminogram, an adapted protein profile and/or an adapted peptide profile include:
a1) demineralized, casein glycomacropeptide (CGMP)-reduced sweet whey and skimmed milk;
a2) demineralized, casein glycomacropeptide (CGMP)-reduced sweet whey;
b1) skimmed milk and CGMP-free acid or native whey;
b2) skimmed milk and CGMP-free acid or sweet whey;
b3) skimmed milk and CGMP-reduced acid or native whey;
b4) skimmed milk and CGMP-reduced acid or sweet whey;
c1) CGMP-free whey protein isolate and sweet whey protein concentrate;
c2) CGMP-free whey protein isolate and hydrolysed sweet whey protein concentrate;
c3) CGMP-reduced whey protein isolate and sweet whey protein concentrate;
c4) CGMP-reduced whey protein isolate and hydrolysed sweet whey protein concentrate;
d1) demineralized CGMP-reduced sweet whey and demineralized sweet whey;
d2) demineralized CGMP-reduced sweet whey sweet whey;
d3) demineralized CGMP-free sweet whey and demineralized sweet whey;
d4) demineralized CGMP-free sweet whey;

Preferred protein sources for use according to the invention include:
a) demineralized, caseino glycomacropeptide (CGMP)-reduced (>85% reduced) sweet whey, for example prepared according to the procedure described in EP 0 986 312 B1, EP 3 256 001 B1 or EP 3 255 999 B1;
b) CGMP-free acid whey;
c) CGMP-free native whey;
d) alpha-lactalbumin-enriched whey protein (alpha-lactalbumin content at least 28 g/100 g protein of complete protein body);
e) partially hydrolyzed 60-70% CGMP free (e.g., native or sweet whey protein) protein isolate and 30-40% sweet whey protein concentrate (WPC);
f) partially hydrolyzed 80-85% CGMP free (e.g., native or sweet whey) or CGMP reduced (>85% reduced, protein content of 25-31% of complete protein body) demineralized protein concentrate (MSW) plus 10-15% sweet whey (protein content of 25-31% of complete protein body) demineralized protein concentrate (DWP); or
g) partially hydrolyzed demineralized CGMP-reduced (52% to 60% reduced) sweet whey demineralized protein concentrate (25-31% of complete protein body), for example prepared according to the procedure described in EP 3 256 001 1 or EP 3 255 999 E1.

In some embodiments, the protein source is an intact protein source. Suitably, the intact protein source comprises:
a) skimmed milk and demineralized, caseino-glyco-macropeptide (CGMP)-reduced-whey;
b) skimmed milk and CGMP-free whey, such as acid, sweet or native whey; or
c) skimmed milk and alpha-lactalbumin-enriched whey protein.

Suitably, the CGMP-free whey is demineralized CGMP-free whey, such as demineralized CGMP-free acid or native whey.

In some embodiments, the protein source is a partially hydrolysed protein source. Suitably, the partially hydrolysed protein source comprises:
a) CGMP-free whey protein isolate and demineralized sweet whey protein concentrate; or
b) demineralized CGMP-reduced sweet whey and demineralized sweet whey.

Suitably, the partially hydrolysed protein source comprises CGMP-free or CGMP-reduced whey protein isolate and demineralized sweet whey protein concentrate.

In one preferred embodiment, the protein source comprises or consists of skimmed milk and demineralized CGMP-reduced sweet whey.

In one embodiment, the protein source comprises or consists of skimmed milk and CGMP-free whey, such as acid or native whey. Suitably, the protein source comprises or consists of skimmed milk and demineralized CGMP-free whey, such as acid or native whey.

In one preferred embodiment, the protein source comprises or consists of CGMP-free whey protein isolate and demineralized sweet whey protein concentrate.

In particular embodiments, the proteins are a combination of demineralized sweet whey and demineralized protein concentrate, such as MSWP80:DWP28.

In one particular embodiment when the protein body comprises hydrolysed or partially hydrolysed whey protein concentrate (WPC (HA)), the protein body also contains hydrolysed or partially hydrolysed whey protein isolate (WPI).

In one particular embodiment, the proteins are a mixture of hydrolysed or partially hydrolysed whey protein concentrate (WPC) and whey protein isolate (WPI). Suitably, the WPI is CGMP-free or CGMP-reduced. Suitably, the WPI is CGMP-free. The WPC:WPI ratio (weight:weight) is 90:10 to 10:90, preferably 60:40 to 10:90, more preferably 50:50 to 20:80, even more preferably 50:50 to 30:70, for example 40:60 to 30:70. In a preferred embodiment, the WPC:WPI ratio (weight:weight) is 37:63. In preferred embodiments, the proteins are a mixtures of WPC and WPI which has been hydrolysed or partially hydrolysed, also called WPC and WPI (HA), such as WPC87:WP195 (HA), wherein 87 and 95 indicate the protein concentrations, the rest being mainly lactose, some minerals and butter fat as will established for the skilled person.

In one embodiment, the protein source comprises or consists of demineralized CGMP-reduced sweet whey and demineralized sweet whey. In one embodiment, the protein source comprises or consists of skimmed milk and alpha-lactalbumin-enriched whey protein.

The casein/whey ratio of the protein source may vary from 80/20 to 0/100. In some advantageous embodiments, the casein/whey ratio in nutritional compositions comprising an intact protein source is 30/70 to 40/60. For example, in starter and follow-on formulas, the ratio may be from 40/60 to 60/40; in growing-up milks the ratio may be from 50/50 to 80/20. The casein/whey ratio in nutritional compositions comprising a partially hydrolysed protein source (such as pre-term formulas) may be from 20/80 to 40/60. In some advantageous embodiments, the casein/whey ratio in a nutritional composition comprising a partially hydrolysed protein source is 0/100.

Suitably, the mixture of skimmed milk and demineralized CGMP-reduced sweet whey is provided with a casein/whey ratio from about 20/80 to about 60/40, preferably of about 20/80.

Suitably, the mixture of skimmed milk and demineralized CGMP-reduced sweet whey comprises 10.1 wt. % of skimmed milk and 16.1 wt. % demineralized CGMP-reduced sweet whey (on dry matter basis). Suitably, the remainder of the mixture is comprised mainly of lactose and lipids.

Suitably, the mixture of skimmed milk and (demineralized) CGMP-free acid whey comprises 10.1 wt. % of skimmed milk and 7.7 wt. % (demineralized) CGMP-free acid whey (dry matter). Suitably, the remainder of the mixture is comprised mainly of lactose and lipids.

Suitably, the mixture of skimmed milk and demineralized CGMP-free native whey comprises 10.1 wt. % of skimmed milk and 7.7 wt. % demineralized CGMP-free native whey (dry matter). Suitably, the remainder of the mixture is comprised mainly of lactose and lipids.

Suitably, the mixture of whey protein isolate CGMP-free and sweet whey protein concentrate comprises CGMP-free whey protein isolate:sweet whey protein concentrate at a ratio of 63:37 on protein basis (dry matter).

Suitably, the mixture of demineralized CGMP-reduced sweet whey and demineralized sweet whey comprises demineralized CGMP-reduced sweet whey:demineralized sweet whey at a ratio of 83:17 on protein basis (dry matter).

In one embodiment, the skimmed milk comprises at least 34 wt. % protein (dry matter), preferably at least 38 wt. % protein, more preferably at least 44 wt. % protein, such as 44 wt. % to 52 wt. % protein, for example 48 wt. % protein (dry matter). In one embodiment, the demineralized CGMP-reduced sweet whey comprises at least 76 wt. % protein (dry matter), preferably at least 80 wt. % protein, more preferably at least 86 wt. % protein, such as 86 wt. % to 94 wt. % protein, for example 90 wt. % protein (dry matter). In one embodiment, the (demineralized) CGMP-free native whey comprises at least 27.5 wt. % protein (dry matter), preferably at least 32 wt. % protein, more preferably at least 38 wt. % protein, such as 38 wt. % to 46 wt. % protein, for example 42 wt. % protein (dry matter). In one embodiment, the CGMP-free whey protein isolate (WPI) comprises at least 95 wt. % protein (dry matter; such as at least 96 wt. %, at least 97 wt. %, at least 98 wt. % protein (dry matter)) and the sweet whey protein concentrate comprises at least 87 wt. % protein (MSWP87) (dry matter), preferably at least 91 wt. % protein, more preferably at least 95 wt. % protein, such as 95 wt. % to 98 wt. % protein, for example 96 wt. % protein (dry matter). In one embodiment, the demineralized CGMP-reduced sweet whey comprises at least 28 wt. % protein (modified sweet whey protein concentrate 28, MSWP28) and the demineralized sweet whey comprises at least 28 wt. % protein (demineralized sweet whey 28, DWP28) (dry matter). In one embodiment, the demineralized CGMP-reduced sweet whey comprises at least 80 wt. % protein (modified sweet whey protein concentrate 80, MSWP80) and the demineralized sweet whey comprises at least 80 wt. % protein (demineralized sweet whey 80, DWP80) (dry matter). In one embodiment, the alpha-lactalbumin-enriched whey protein comprises at least 68 wt. % protein (dry matter), preferably at least 72 wt. % protein, more preferably at least 78 wt. % protein, such as 78 wt. % to 86 wt. %, for example 82 wt. % (dry matter).

Suitable acid whey protein concentrates for use in the invention with 28% protein include aDWP28, sold by Paras of India, acid whey protein concentrate 80 (AWPC 80, LAC 7009) sold by Fonterra of New Zealand. Suitable native whey protein concentrates for use in the invention include native whey 28 (nDWP28) sold by Euroserum of France, native whey protein concentrate 80 (nWPC 80) sold by Leprino of the USA, and native whey protein isolate with 95% protein (Pronative 95) sold by Lactalis of France. Suitable demineralized CGMP-free acid whey protein sources for use in the invention include WPC 80 Lac7009 sold by Fonterra of New Zealand. Suitable demineralized CGMP-free native whey protein sources for use in the invention include Native Whey 28 sold by Euroserum of France. Suitable CGMP-free whey protein isolates for use in the invention include BiPro 9500 sold by Agropur of the USA. Suitable sweet whey protein concentrates for use in the invention include whey protein concentrate 80 (WPC80) sold by Leprino of the USA and whey protein concentrate 87 (WPC87) sold by Milei of Germany or Lacprodan DI-8590 sold by Arla Foods of Denmark. Suitable demineralized sweet whey protein for use in the invention include demineralized Whey 90 (DM90) or DWP3 sold by Euroserum of France, as well as demineralized whey protein powder/liquid 28 (DWP28) sold by Euroserum of France, Lactalis of France and Friesland Campina of the Netherlands. Suitable alpha-lactalbumin-enriched whey protein for use in the invention include the Hilmar™ 8800 alpha-lactalbumin enriched whey protein concentrate sold by Hilmar of the USA. Suitable CGMP-reduced sweet whey protein for use according to the invention include modified sweet whey liquid and powder (CGMP reduced more than 85%) sold by Nestle of Switzerland, modified sweet whey powder and liquid 16% protein content sold by Nestle of Switzerland, modified sweet whey powder and liquid 28% protein content MSWP28 sold by Euroserum of France and Leprino of the USA, modified sweet whey protein concentrate with 80% proteins (MSWP 80) sold by Leprino of the USA, and modified sweet whey protein isolate (WPI) like for example Bipro (WP195) sold by Agropure of the USA.

ILA is a metabolite of tryptophan which may be produced by a LNFP-1 metabolizing Bifidobacterium, for example Bifidobacterium longum subsp. infantis. Thus, the protein source for use in the invention is a tryptophan-rich protein source.

In some embodiments, the protein source comprises tryptophan or a salt thereof.

In some embodiments, the protein source comprises from about 1.8 g to about 3.1 g of tryptophan per 100 g of total powder (nutritional composition, dry matter). Suitably, the protein source comprises from about 2 g to about 3 g of tryptophan per 100 g of total powder, such as from about 2.25 g to about 2.75 g of tryptophan per 100 g of total powder. Preferably, the protein source comprises about 2.48 g of tryptophan per 100 g of total powder.

In some embodiments, metabolites are further derived from phenylalanine. Suitably, the protein source comprises phenylalanine or a salt thereof.

In some embodiments, the protein source comprises from about 0.25 g to about 1.0 g of phenylalanine per 100 g of total powder (nutritional composition, dry matter). Suitably, the protein source comprises from about 0.4 g to about 0.7 g of phenylalanine per 100 g of total powder, such as from about 0.52 g to about 0.59 g of phenylalanine per 100 g of total powder. Preferably, the protein source comprises about 0.56 g of phenylalanine per 100 g of total powder.

In some embodiments, metabolites are further derived from tyrosine. Suitably, the protein source comprises tyrosine or a salt thereof.

In some embodiments, the protein source comprises from about 0.15 g to about 0.9 g of tyrosine per 100 g of total powder (nutritional composition, dry matter). Suitably, the protein source comprises from about 0.2 g to about 0.6 g of tyrosine per 100 g of total powder, such as from about 0.35 g to about 0.45 g of tyrosine per 100 g of total powder. Preferably, the protein source comprises about 0.40 g of tyrosine per 100 g of total powder.

The protein source may comprise tryptophan, phenylalanine and/or tyrosine in any suitable form, for example in the form of a free amino acid, salt (e.g. sodium or potassium salts), oligopeptide, polypeptide, or protein.

In some preferred embodiments, the protein sources for use in the invention are hydrolyzed at a degree of hydrolysis (DH) of from 7 to 11%, preferably of from 8.3 to 10.8%, as determined using Assay 1 (described below).

In some preferred embodiments, the protein source for use in the invention are hydrolysed to an average molecular weight of from 941 to 1284 Da (with 3 sigma), preferably to an average molecular weight of 1112 Da or 1155 Da. Protein Molecular Weights (MW) are determined by size exclusion chromatography with a specific post-column labelling and a fluorescence detection based on a calibration curve established with known MW of commercial proteins as described below.

### Assay 1

In protein hydrolysates, the DH is defined as the percentage of peptides bonds cleaved through hydrolysis which is assessed on pure individual protein (Nielsen et al., 2001, J. Food Sci., 66: 642-646). The DH is expressed by equation (1), wherein h represents the number of hydrolyzed peptide bonds in the protein hydrolysate and hₜₒₜ represents the total number of peptide bonds in the protein source material available for hydrolysis.

$$DH ( \% ) = \frac{number of hydrolysed peptide bonds}{total number of peptide bonds} * 100 = \frac{h}{{h}_{tot}} * 100 \qquad ( 1 )$$

Equation (1) can be sub-divided into the following subsections:

1. Total Number of Peptide Bonds (hₜₒₜ)

The derivation of hₜₒₜ is described in detail in the publication from Nielsen et al. (supra). Based on these published data for hₜₒₜ a value of 8.8 mmole/g protein is reported for whey protein.

### 2. Number of Hydrolysed Peptide Bonds (h)

To determine the number of hydrolysed peptide bonds (h), the ratio of free amino nitrogen groups (AN) and total nitrogen content (TN) in the protein source material (ANᵢₙᵢₜᵢₐₗ) is substracted from the ratio AN/TN in the protein hydrolysate (AN_{final}) leading to the following equation (2):

$$h = {AN}_{final} - {AN}_{initial} = \% AN / TN ( protein hydrolysate ) - \% AN / TN ( protein source material ) \qquad ( 2 )$$

The free amino nitrogen groups (AN) [α- and ε-amino groups] are determined by reaction with trinitrobenzenesulfonic acid [TNBS] based on the procedure described by Adler-Nissen (Adler-Nissen, 1979, J Agric Food Chem, 27:1256-62). This method is a spectrophotometric assay of the chromophore specifically formed by the reaction of TNBS with free amino groups. The reaction takes place in slightly alkaline conditions. The reaction products are measured at an absorbance of 340 nm.

The total nitrogen content (TN) is determined via the Kjeldahl method (Kjeldahl, J., 1883, Zeitschrift für analytische Chemie, 22: 366-383).

### Determination of Protein Molecular Weight

For determination of the hydrolysates molecular weight distribution (MWD), size exclusion chromatography (SEC) preferably using a Superdex 30 Increase column (Cytiva) with UV detection is used. A complete description of the method used for determination of MWD characterization is described by Johns P. W. et al. and Bourdeau et al. (Johns P. W. et al., 2011, Food Chemistry, 125, 1041-1050; and Bourdeau et al., 2021, Nutrients, 13: 3011).

In order to obtain MW information for the peptide size distribution, the elution time axis is calibrated (cubic fitting) using the following 17 standard proteins, peptides and free amino acids: (1) serum albumin (bovine, MW~66′354), (2) ovalbumin (chicken, MW~42′750), (3) carbonic anhydrase (bovine, MW~28′964), (4) beta-lactoglobulin (bovine, MW~18′264), (5) alpha-lactalbumin (bovine, MW~14′168), (6) ubiquitin (bovine, MW~8′564), (7) insulin (bovine, MW~5′733), (8) vasoactive intestinal peptide (VIP, mouse, MW~3′325), (9) dynorphin A (porcine, MW~2′147), (10) substance P (horse, MW~1′347), (11) angiotensin II (human, MW~1′046), (12) MRFA tetrapeptide (MW~607), (13) IPP tripeptide (MW~325), (14) VPP tripeptide (MW~311), (15) IL dipeptide (MW~245), (16) GGG tripeptide (MW~189), (17) AA18 mix (mix of 18 amino acids, average MW~110). Wherein the MW are given in Dalton (Da).

Alternatively, the mass range was calibrated with a mix of 8 reference compounds (beta-lactoglobulin: 18′264 Dalton (Da); ubiquitin: 8′564 Da; insulin B-chain: 3′494 Da; substance P: 1′347 Da; bradykinin: 1′060 Da; Glys: 360 Da; Glys: 189 Da; His (representing an average amino acid): 110 Da) and cubic fitting.

### Formulation

The nutritional composition according to the invention can be for example an infant formula, a starter infant formula, a follow-on or follow-up formula, a growing-up milk, a baby food, an infant cereal composition, a fortifier such as a human milk fortifier, a supplement, a pet food, or a pet food supplement. In some particular embodiments, the composition of the invention is an infant formula, a fortifier or a supplement that may be intended for the first 4 or 6 months of age. In a preferred embodiment the nutritional composition of the invention is an infant formula.

The combination according to the invention can be for example formulated as an infant formula, a starter infant formula, a follow-on or follow-up formula, a growing-up milk, a baby food, an infant cereal composition, a fortifier such as a human milk fortifier, a supplement, a pet food, or a pet food supplement.

In some other embodiments, the nutritional composition or combination of the present invention is a fortifier. The fortifier can be a breast milk fortifier (e.g. a human milk fortifier) or a formula fortifier such as an infant formula fortifier or a follow-on/follow-up formula fortifier.

When the nutritional composition or combination is a supplement, it can be provided in the form of unit doses. In such cases it is particularly useful to define the amount of oligosaccharides and probiotics in terms of daily dose to be administered to the infant, young child or child.

When the nutritional composition or combination is a supplement, it may comprise LNFP-I, a galactose source and a LNFP-1 metabolizing Bifidobacterium, for example B. infantis, and no other additional nutrient on top of the excipients necessary to obtain a stable nutritional composition.

The nutritional composition or combination of the present invention can be in solid (e.g. powder), liquid or gelatinous form. In a specific embodiment the nutritional composition or combination is a supplement, wherein the supplement is in powder form and provided in a sachet, preferably a sachet with 0.1 to 20 g per sachet, for example 1 to 10 g per sachet, or in the form of a syrup, preferably a syrup with a total solid concentration of 5 to 75 g/100 mL (5 to 75% (w/v)). When the supplement is in powder form, it may comprise a carrier. It is however preferred that the supplement is devoid of a carrier. When the supplement is in the form of a syrup, the components are preferably dissolved or suspended in water acidified with citrate.

In a particular embodiment the nutritional composition or the combination according to the invention is a hypoallergenic composition. In another particular embodiment the composition or combination according to the invention is a hypoallergenic nutritional composition.

### Manufacture of a Nutritional Composition

The nutritional composition or combination according to the invention may be prepared in any suitable manner. A composition will now be described by way of example.

For example, a formula such as an infant formula may be prepared by blending together the protein source, the carbohydrate source and the fat source in appropriate proportions. If used, the emulsifiers may be included at this point. The vitamins and minerals may be added at this point but they are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture. The temperature of the water is conveniently in the range between about 50° C. and about 80° C. to aid dispersal of the ingredients. Commercially available liquefiers may be used to form the liquid mixture.

The oligosaccharide(s) may be added at this stage, especially if the final product is to have a liquid form. If the final product is to be a powder, they may likewise be added at this stage if desired.

The liquid mixture is then homogenised, for example in two stages.

The liquid mixture may then be thermally treated to reduce bacterial loads, by rapidly heating the liquid mixture to a temperature in the range between about 80° C. and about 150° C. for a duration between about 5 seconds and about 5 minutes, for example. This may be carried out by means of steam injection, an autoclave or a heat exchanger, for example a plate heat exchanger.

Then, the liquid mixture may be cooled to between about 60° C. and about 85° C. for example by flash cooling. The liquid mixture may then be again homogenised, for example in two stages between about 10 MPa and about 30 MPa in the first stage and between about 2 MPa and about 10 MPa in the second stage. The homogenised mixture may then be further cooled to add any heat sensitive components, such as vitamins and minerals. The pH and solids content of the homogenised mixture are conveniently adjusted at this point.

If the final product is to be a powder, the homogenised mixture is transferred to a suitable drying apparatus such as a spray dryer or freeze dryer and converted to powder. The powder should have a moisture content of less than about 5% by weight. The oligosaccharide(s) may also or alternatively be added at this stage by dry-mixing or by blending them in a syrup form of crystals, along with the probiotic strain(s), and the mixture is spray-dried or freeze-dried.

If a liquid composition is preferred, the homogenised mixture may be sterilised then aseptically filled into suitable containers or may be first filled into the containers and then retorted.

In another embodiment, the composition or combination of the invention may be a supplement. The supplement may be in the form of tablets, capsules, pastilles or a liquid for example. The supplement may further contain protective hydrocolloids (such as gums, proteins, modified starches), binders, film forming agents, encapsulating agents/materials, wall/shell materials, matrix compounds, coatings, emulsifiers, surface active agents, solubilizing agents (oils, fats, waxes, lecithins etc.), adsorbents, carriers, fillers, co-compounds, dispersing agents, wetting agents, processing aids (solvents), flowing agents, taste masking agents, weighting agents, jellifying agents and gel forming agents. The supplement may also contain conventional pharmaceutical additives and adjuvants, excipients and diluents, including, but not limited to, water, gelatine of any origin, vegetable gums, lignin-sulfonate, talc, sugars, starch, gum arabic, vegetable oils, polyalkylene glycols, flavouring agents, preservatives, stabilizers, emulsifying agents, buffers, lubricants, colorants, wetting agents, fillers, and the like.

Further, the supplement may contain an organic or inorganic carrier material suitable for oral or parenteral administration as well as vitamins, minerals trace elements and other micronutrients in accordance with the recommendations of Government bodies such as the USRDA.

### Use

The present inventors have surprisingly found that a LNFP-1 metabolizing Bifidobacterium, for example Bifidobacterium longum subsp. infantis has the ability to efficiently catabolise LNFP-1. Thus, the composition or combination of the present invention will increase the abundance of a LNFP-1 metabolizing Bifidobacterium, for example Bifidobacterium longum subsp. infantis in the gastrointestinal tract of a subject administered the composition or combination of the invention.

Accordingly, in a further aspect, the invention provides the use of a nutritional composition or combination of the invention for modulating the microbiota of a subject.

In a further aspect, the invention provides a method of modulating the microbiota of a subject, the method comprising administering the nutritional composition of the invention or combination of the invention to the subject.

Suitably, modulating the microbiota of a subject comprises increasing the abundance of Bifidobacteriaceae and/or a LNFP-1 metabolizing Bifidobacteria, for example Bifidobacterium longum subsp. infantis in the gastrointestinal tract of the subject.

Suitably, the relative abundance of Bifidobacteriaceae and/or a LNFP-1 metabolizing Bifidobacteria, for example Bifidobacterium longum subsp. infantis in the gastrointestinal tract of the subject is increased. Suitably, the abundance of Bifidobacteriaceae and/or a LNFP-1 metabolizing Bifidobacterium, for example Bifidobacterium longum subsp. infantis (or relative abundance of Bifidobacteriaceae and/or a LNFP-1 metabolizing Bifidobacterium, for example Bifidobacterium longum subsp. infantis) is increased in a subject using a nutritional composition or combination according to the invention when compared to a corresponding nutritional composition which does not comprise LNFP-1 and a galactose source having the structure of Formula I.

The present inventors have surprisingly found that the combination of LNFP-I and a galactose source having the structure of Formula I increases the production of indole-3-lactic acid (ILA) by a LNFP-1 metabolizing Bifidobacterium, for example Bifidobacterium longum subsp. infantis.

Accordingly, in a further aspect, the invention provides the use of a nutritional composition or combination of the invention for increasing the levels of ILA in the gastrointestinal tract of a subject.

In a further aspect, the invention provides a method of increasing the levels of ILA in the gastrointestinal tract of a subject, the method comprising administering the nutritional composition of the invention or combination of the invention to the subject.

Suitably, the biosynthesis of ILA by a LNFP-1 metabolizing Bifidobacterium, for example the Bifidobacterium longum subsp. infantis in the subject is increased from 1.1 to 20-fold, such as by 1.2 to 11-fold, preferably by 4-fold to 11-fold. Suitably, the biosynthesis of ILA by a LNFP-1 metabolizing Bifidobacterium, for example the Bifidobacterium longum subsp. infantis in the subject is increased by at least 1.1-fold, such as by 1.2-fold, 1.3-fold, 1.4-fold, 1.5-fold, 2-fold, 3-fold, 4-fold, 5-fold, 6-fold, 7-fold, 8-fold, 9-fold, 10-fold, 15-fold or 20-fold.

Suitably, the base-2 logarithm of the ratio between the value of ILA for the combination or composition according to the invention and the value of ILA for a corresponding nutritional composition which does not comprise LNFP-1 and a galactose source having the structure of Formula I is increased by from 0.2 to 5, suitably from 0.25 to 3.8.

The amount of ILA secreted (i.e. ILA biosynthesis) by a LNFP-1 metabolizing Bifidobacterium, for example Bifidobacterium longum subsp. infantis in the gastrointestinal tract of the subject may be measured by methods known in the art. Suitably, the amount of ILA in fresh fecal samples from an infant, young child or child fed the combination or nutritional composition according to the invention may be compared to samples from an infant, young child or child not exposed to a combination or nutritional composition according to the invention (Henrick et al., 2021, Cell, 184: 3884-3898; and Laursen et al., Nat Microbiol., 2021, 6: 1367-1382).

### Therapeutic Use

Bifidobacterium is one of the main genera of commensal bacteria present in the human gastrointestinal tract and its presence has been related to health benefits in several studies (Hidalgo-Cantabrana, C., et al., 2017. Microbiology spectrum, 5(3), pp. 5-3). As described above, the use of probiotics, including Bifidobacteria strains, in preventive medicine to maintain a healthy intestinal function is well-documented (Tojo, R., et al., 2014. World journal of gastroenterology: WJG, 20(41), p. 15163).

SCFAs have a well-known role in immune protection against infection and regulation. In particular, SCFAs have been shown to promote host antibody responses (Kim et al., 2016, Cell Host & Microbe, 20(2): 202-214), protect against respiratory infections such as respiratory syncytial virus infection (Antunes et al., 2019, Nat Commun 10: 3273; and Dogra et al., Microorganisms, 2021, 9: 1939), enhance antimicrobial function of macrophages (and thereby boost the host defence against infections) (Schulthess et al., 2019, Immunity, 50(2): 432-445; and Machado et al., 2022, Front. Immunol., https://doi.org/10.3389/fimmu.2022.773261), protect against influenza virus infection or enhance the immune response to influenza virus (Trompette et al., 2018, Immunity, 48(5): 992-1005; and Moriyama and Ichinoe, 2019, PNAS, 116(8): 3118-3125), and protect against respiratory syncytial virus (RSV)-bronchiolitis (Lynxh et al., 2018, J Exp Med., 215(2): 537-557). The SCFA butyrate has been shown to provide various health benefits and especially to protect against obesity, insulin resistance, diabetes, to be involved in adipogenesis, in food intake, in the prevention of non-alcoholic fatty liver disease or of cardiometabolic related conditions like development of atherosclerosis, in the prevention/treatment of inflammation, infections, allergies, in the gut maturation, the gut brain axis connection, the colonic healing especially in case of colitis and to have anti-cancer effects (Lin et al., Butyrate and Propionate Protect against Diet-Induced Obesity and Regulate Gut Hormones via Free Fatty Acid Receptor 3-Independent Mechanisms, 2012; Aguilar et al, “Butyrate impairs atherogenesis by reducing plaque inflammation and vulnerability and decreasing N FKB activation”, 2015; Endo et al, “Butyrate-producing probiotics reduce nonalcoholic fatty liver disease progression in rats: new insight into the probiotics for the gut-liver axis”, 2013; Goverse et al, Diet-derived short chain fatty acids stimulate intestinal epithelial cells to induce mucosal tolerogenic dendritic cells, 2017; Canani et al, Potential beneficial effects of butyrate in intestinal and extraintestinal diseases, 2011; Nylund et al, Severity of atopic disease inversely correlates with intestinal microbiota diversity and butyrate-producing bacteria, 2015; Stilling et al, The neuropharmacology of butyrate: The bread and butter of the microbiota-gut-brain axis?, 2016).

ILA has been shown to have an anti-inflammatory effect in the gastrointestinal tract of infants, which is known to reduce the risk of developing allergies, asthma, and other inflammatory diseases later in life as well as reducing the risk of developing necrotizing enterocolitis (NEC) (Meng et al., 2020, Pediatr. Res., 88: 209-217; Laursen et al., Nat Microbiol., 2021, 6: 1367-1382; Henrick et al., 2021, Cell, 184: 3884-3898; Huang et al., 2021, Scientific Reports, 11: 8088; and Erlich et al., 2020, BMC Microbiology, 20: 357). The composition or combination of the invention is therefore particularly advantageous for promoting a healthy immune system in a subject and preventing and/or reducing inflammation in the intestine of a subject. 3-Phenyllactate or phenyllactic acid (PLA) is a phenolic acid synthesized during phenylalanine and central carbon metabolism of LAB and other bacterial species such as Bifidobacterium longum subsp. infantis). Specifically, PLA is likely produced from phenylpyruvate via the action of lactate dehydrogenase. PLA is an important broad-spectrum antimicrobial compound that inhibits the growth of undesirable microbes through multifaceted actions. The chemical structure of 3-phenyllactic acid is:

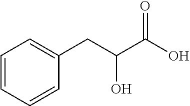 [SMILES: O=C(O)C(O)Cc1ccccc1]

3-Phenyllactate (PLA) has been demonstrated to exert powerful anti-microbial activity against pathogenic species (Chaudhari and Gokhale, 2016, J Bacteriol Mycol Open Access, 2:121-125; and Wanmeng Mu et al., 2012, Appl Microbiol Biotechnol, 95:1155-1163). PLA has been shown to efficiently inhibit the growth of E. coli, Listeria spp. and Salmonella spp., via a variety of mechanisms (Ning et al., 2017, Food Chemistry, 228: 533-540; and Rodriguez et al., 2012, Food Control, 25: 274-284).

The use of the combination or composition of the invention, which enhances the growth of a LNFP-1 metabolizing Bifidobacterium, for example Bifidobacterium longum subsp. infantis and/or increases the levels of SCFA and/or increases the levels of ILA and/or increases the levels 3-phenyllactate (PLA) in the gastrointestinal tract of the subject would be expected to have the same effects as the administration of the probiotics or SCFAs or ILA or PLA discussed above.

Accordingly, in a further aspect, the present invention provides the combination or nutritional composition of the invention for use as a medicament. In a further aspect, the present invention provides the use of the combination or nutritional composition of the invention for the manufacture of a medicament.

In a further aspect, the invention provides a nutritional composition according to the invention for use in:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject.

In one embodiment, the nutritional composition according to the invention is for use in preventing and/or treating viral and/or bacterial infections in a subject. In one embodiment, the nutritional composition according to the invention is for use in preventing and/or treating necrotizing enterocolitis (NEC) in a subject. In one embodiment, the nutritional composition according to the invention is for use in preventing and/or reducing inflammation in the intestine of a subject. In one embodiment, the nutritional composition according to the invention is for use in promoting a healthy immune system in a subject. In one embodiment, the nutritional composition according to the invention is for use in modulating the microbiota of a subject.

In a further aspect, the invention provides a method of preventing and/or treating viral and/or bacterial infections in a subject, preventing and/or treating necrotizing enterocolitis (NEC) in a subject, preventing and/or reducing inflammation in the intestine of a subject, promoting a healthy immune system in a subject and/or modulating the microbiota of a subject, the method comprising administering the nutritional composition of the invention to the subject.

In some embodiments, the composition of the invention exerts the above beneficial health effects by increasing the levels of ILA in the gastrointestinal tract of the subject. Suitably, the levels of ILA in the subject may be increased as described herein above.

In some embodiments, modulating the microbiota of a subject comprises increasing the abundance of Bifidobacteriaceae and/or Bifidobacterium longum subsp. infantis in the gastrointestinal tract of the subject. Suitably, the abundance of Bifidobacteriaceae and/or Bifidobacterium longum subsp. infantis may be increased as described herein above.

The composition according to the invention may also be for use in promoting healthy growth, promoting a healthy gut function, preventing and/or treating microbiota dysbiosis and/or preventing and/or treating allergy in a subject.

The combination or nutritional composition of the invention may prevent or treat an infection or a disease by increasing the levels of SCFA in the gastrointestinal tract and systemic levels of SCFA of the subject. The increased systemic levels of SCFA in the subject facilitates the exertion of the effects of the combination or nutritional composition of the invention beyond the gastrointestinal tract (e.g. in the lungs).

The combination or nutritional composition of the invention may prevent or treat an infection or a disease by increasing the levels of ILA in the gastrointestinal tract of a subject.

The combination or nutritional composition of the invention may prevent or treat an infection or a disease by enhancing the growth of a LNFP-1 metabolizing Bifidobacterium, for example Bifidobacterium longum subsp. infantis in the gastrointestinal tract of the subject.

The combination or composition of the invention may be used to treat or prevent disorders associated with decreased numbers of Bifidobacteria in the gut (see e.g. Riviere, A., et al., 2016. Frontiers in microbiology, 7, p. 979).

In one aspect, the invention provides the combination or composition of the invention for use in treating and/or preventing a disorder associated with decreased numbers of Bifidobacteria in the gut. In another aspect, the invention provides for use of the combination or composition of the invention for the manufacture of a medicament for treating and/or preventing a disorder associated with decreased numbers of Bifidobacteria in the gut. In another aspect, the invention provides a method of treating and/or preventing a disorder associated with decreased numbers of Bifidobacteria in the gut in a subject, comprising administering the combination or composition of the invention to the subject.

Suitably, the disorder associated with decreased numbers of Bifidobacteria in the gut in a subject may be selected from: a gastrointestinal disease, obesity, an allergic disease, and regressive autism.

The beneficial health benefits provided by the composition of the invention can be short term and/or long term effects.

The effect may be immediate with the administration of the composition of the present invention, or later in life, i.e. after the administration of the composition, e.g. from 1 week to several months or years, for example from 2 to 4 weeks, from 2 to 6 weeks, from 2 to 8 weeks, from 1 to 6 months, from 2 to 12 months, or from 6 months to 12 years, such as from 2 years to 10 years, from 4 years to 5 years, after said administration.

### Bacterial Infection

The composition of the invention is, in particular, effective for use in the treatment and/or prevention of a bacterial infection in a subject.

Accordingly, the composition of the invention is also effective for use in reducing the risk of contracting a bacterial infection in a subject and/or for use in reducing the symptoms associated with a bacterial infection in subject.

The bacterial infection may be a gastrointestinal infection or a respiratory tract infection. The gastrointestinal infection may be an intestinal infection or a stomach infection. Particular examples of bacterial pathogens are Clostridium difficile (e.g. Clostridium difficile toxin A/B), Campylobacter, Escherichia coli (e.g. E. coli O157).

In a preferred embodiment, the bacterial infection is a bacterial respiratory tract infection. The bacterial respiratory tract infection may be a bacterial infection in the upper respiratory tract or in the lower respiratory tract.

The symptoms most often associated with the bacterial infection, and which may be reduced by the composition of the invention, are irritation in the lungs, congestion in the lungs, excessive mucus production, fever, cough, wheezing, breathlessness, abdominal cramps, diarrhoea or vomiting. Suitably, the symptoms are abdominal cramps, diarrhoea or vomiting.

### Viral Infection

The composition of the invention is, in particular, effective for use in the treatment and/or prevention of a viral infection in a subject.

Accordingly, the composition of the invention is also effective for use in reducing the risk of contracting a viral infection in a subject and/or for use in reducing the symptoms associated with a viral infection in subject.

The viral infection may be a viral gastrointestinal infection or a viral respiratory tract infection. The viral gastrointestinal infection may be a viral intestinal infection or a viral stomach infection.

In a preferred embodiment, the viral infection is a viral respiratory tract infection. The viral respiratory tract infection may be a viral infection in the upper respiratory tract or in the lower respiratory tract. In a typical embodiment of the invention, the viral respiratory tract infection is caused by respiratory syncytial virus (RSV).

The disease associated with the viral infection will typically be common cold, influenza (flu), bronchitis, bronchiolitis, pneumonia, sore throat (pharyngitis), sinusitis, non-allergic rhinitis, severe acute respiratory syndrome (SARS), viral croup, otitis media, meningitis or diarrhoea. Typically, when the viral infection is in the respiratory tract, the disease associated with the respiratory tract infection is common cold, influenza (flu), bronchitis, bronchiolitis, pneumonia, sore throat (pharyngitis), sinusitis, non-allergic rhinitis, severe acute respiratory syndrome (SARS), viral croup or otitis media. Most often, the disease associated with the viral respiratory tract infection is common cold, influenza (flu), bronchitis, bronchiolitis or pneumonia.

Accordingly, in a preferred embodiment of the invention the composition of the invention is for use in treating and/or preventing a disease associated with a viral respiratory tract infection selected from the group consisting of common cold, influenza (flu), bronchitis, bronchiolitis and pneumonia. In a more preferred embodiment, the disease associated with the respiratory tract infection is selected from the group consisting of bronchiolitis and pneumonia, in particular bronchiolitis and pneumonia caused by RSV. In an even more preferred embodiment, the disease associated with the respiratory tract infection is bronchiolitis, in particular bronchiolitis caused by RSV.

The symptoms most often associated with the viral infection, and which may be reduced by the composition of the invention, are irritation in the lungs, congestion in the lungs, excessive mucus production, fever, cough, wheezing, breathlessness, abdominal cramps, diarrhoea or vomiting.

The above-mentioned infections may be caused by a variety of different viruses, including respiratory syncytial virus (RSV), parainfluenza virus (PIV), influenza virus such as influenza virus A (IVA) and/or influenza virus B (IVB), rhinovirus (RV), adenovirus (ADV), metapneumovirus (MPV), bocavirus (BoV), coronavirus (CoV), myxovirus, herpesvirus, enterovirus (EV), parachovirus (PeV) or a combination thereof.

The composition of the invention is particularly effective in treating, preventing, reducing the risk of contracting and/or reducing the symptoms of a viral infections caused by respiratory syncytial virus (RSV). Thus, composition of the invention is particularly preferred for use in treating, preventing, reducing the risk of contracting and/or reducing the symptoms of bronchiolitis caused by respiratory syncytial virus (RSV) or pneumonia caused by respiratory syncytial virus (RSV).

Since respiratory viral infections are also a major determinant for development of pulmonary diseases, such as chronic obstructive pulmonary disease (Savran et al, Int J Chron Obstruct, 2015; 191; 34-44), later in life, the composition of the invention is also suitable for use in preventing or reducing the risk of developing pulmonary diseases, in particular chronic obstructive pulmonary disease, in a mammal, such as a human.

Since viral infections, in particular infection with RSV, is often associated with bacterial co-infection (Thorburn et al, Thorax, 2006; 61(7); 611-615) or secondary infection (Sande et al, Nature Communications, 2019; 10; 2218), including antibiotic use, the composition of the invention is also effective for use in preventing or reducing the risk of a bacterial co-infection and/or a bacterial secondary infection associated with respiratory viral infection in a mammal, in particular a human. Pathogenic bacteria typically involved in co-infections or secondary infections include Staphylococcus aureus, Streptococcus pneumoniae and/or Haemophilus influenza.

The composition of the invention is useful for treating and/or preventing viral infections, in particular respiratory tract infection in a human of any age. Thus, the human to be treated with the composition of the invention may be selected from the group consisting of 0 to <1 year (infants), 1 to <3 years (young children) and 3 to <5 years (children).

Since viral infections, in particular infection with RSV, is associated with subsequent development of allergic airway diseases, such as asthma later in life (Feldman et al. 2015 Am J Respir Crit Care Med, 191; 34-44), the composition of the invention is also effective for use in preventing or reducing the risk of allergen sensitisation and/or developing an allergic respiratory tract disease in a mammal, such as a human. Examples of allergic respiratory tract diseases include asthma and recurrent wheeze, in particular asthma.

In this case, the composition of the invention is preferably administered to a human having an age from 0 to <3 years, preferably from 0 to 2 years, more preferably from 0 to <1 year, such as from 0 to 6 months. This, in turn, prevents or reduces the risk of developing an allergic respiratory tract disease when said human has reached an age of 3 years or more, preferably from 3 to 12 years, more preferably from 3 to 10 years, even more preferably from 3 to 8, most preferably from 3 to 6 years, in particular from 3 to 5 years or from 3 to 4 years.

### Necrotising Enterocolitis

Necrotizing enterocolitis (NEC) is an intestinal disease that affects premature infants. It has been shown that probiotic supplementation with Bifidobacteria can reduce both the incidence and severity of NEC in a premature neonatal population (Bin-Nun, A., et al., 2005. The Journal of pediatrics, 147(2), pp. 192-196). Moreover, ILA has been shown to have an anti-inflammatory effect in the infant intestine which is expected to prevent NEC (Meng et al., 2020, Pediatr. Res., 88: 209-217).

In some preferred embodiments, the composition or combination of the invention is for use in treating and/or preventing NEC in a subject.

### Intestinal Inflammation

ILA has been shown to have an anti-inflammatory effect in the gastrointestinal tract of infants, which is known to reduce the risk of developing allergies, asthma, and other inflammatory diseases later in life as well as reducing the risk of developing necrotizing enterocolitis (NEC) (Meng et al., 2020, Pediatr. Res., 88: 209-217; Henrick et al., 2021, Cell, 184: 3884-3898; Huang et al., 2021, Scientific Reports, 11: 8088; and Erlich et al., 2020, BMC Microbiology, 20: 357).

The use of the combination or composition of the invention, which increases the levels of ILA in the gastrointestinal tract of the subject would be expected to have the same effects as ILA discussed above.

Accordingly, in some preferred embodiments, the composition or combination of the invention is for use in preventing and/or reducing intestinal inflammation in a subject.

The prevention or reduction of inflammation in the intestine of a subject may be determined using methods known in the art (see, for example, Henrick et al., 2021, Cell, 184: 3884-3898; and Laursen et al., Nat Microbiol., 2021, 6: 1367-1382).

The composition of the infant gut microbiome is critical to immunological development, particularly during the first 3 months of life, when differences in gut microbial composition are most influential in impacting the developing immune system.

Bifidobacterium longum subsp. infantis has been demonstrated to predominate in the gut microbiota of breastfed infants and to benefit the host by accelerating maturation of the immune response and balancing the immune system to suppress inflammation. Reduced abundance of Bifidobacterium species in infants and young children has been correlated to chronic diseases, including asthma and obesity, as well as to increased incidence of allergic and autoimmune diseases later in life. The anti-inflammatory effects of Bifidobacterium longum subsp. infantis may at least in part be effected by the production of ILA.

The composition or combination of the present invention increases the levels of ILA and a LNFP-1 metabolizing Bifidobacterium, for example Bifidobacterium longum subsp. infantis in the gastrointestinal tract of a subject.

Accordingly, in some preferred embodiments, the composition or combination of the invention is for use in promoting a healthy immune system in a subject. Suitably, promoting a healthy immune system in a subject comprises promoting immune homeostasis and/or preventing and/or reducing inflammation. The promotion of immune homeostasis in a subject may be determined using methods known in the art (see, for example, Wei et al., FASEB J, 2020, 34: 16117-16128).

### Subject

In some embodiments, the subject is a mammal, such as a human.

In some embodiments, the nutritional composition or combination according to the invention is for use in infants, young children or children.

In one embodiment, the subject is an infant. In one embodiment, the subject is a young child. In one embodiment, the subject is a child.

The nutritional composition according to the invention is for use in infants or young children. It is particularly adapted for infants under 6 months of age.

The infants, young children or children may be born term or preterm. In a particular embodiment, the nutritional composition or combination of the invention is for use in infants, young children or children that were born preterm. Preterm infants may be at increased risk of poor nutrient utilization, impaired lean body mass growth, fat accumulation in the visceral area and metabolic disease later in life. Thus, in one embodiment the nutritional composition or combination of the invention is for use in preterm infants.

In one embodiment, the subject is an infant or a young child that was born small for gestational age or low birth weight.

Infants or young children with low birth weight may or may not be preterm, and similarly, infants or young children who are small for gestational age may or may not be preterm.

The nutritional composition of the present invention may also be used in an infant or a young child that was born by C-section or that was vaginally delivered.

All infants and young children can benefit from the invention as all of them are or can be, at a certain age, susceptible to acquiring an unbalanced intestinal/gut microbiota.

In some advantageous embodiments of the invention, the nutritional composition in for use infants or young children having a fragile or unbalanced microbiota or dysbiosis of microbiota, such as preterm infants, infants born by Caesarean-section, infants born small for gestational age or with low birth weight, hospitalized infants/young children, infants/young children treated or having been treated by antibiotics and/or infants/young children suffering or having suffered from gut infection and/or gut inflammation.

It is indeed foreseen that the composition of the invention may be even more beneficial to infants born with possibly impaired gut microbiota or fragile infants/young children (such as prematurely born infants and/or infants born by C-section). It is also foreseen that the composition of the invention may be even more beneficial to infants/young children exhibiting intestinal disorders (such as diarrhea, infections or colic), especially after birth, for example, during the first 4 weeks after birth.

In embodiments of the invention, the infants born prematurely or born by caesarean section or born small for gestational age or with low birth weight, or exhibiting unbalanced or abnormal gut microbiota or suffering or having suffered from gut infection and/or gut inflammation, are targeted by the composition of the present invention, and especially when the infants are 0-6 months of age. Without being bound by the theory, it is believed that younger infants benefit even more from the composition of the invention, especially when the infants have (or are at risk of having) an unbalanced intestinal microbiota and/or have a fragile health condition (as exemplified by the conditions cited above).

The nutritional composition can be administered (or given or fed) at an age and for a period that depends on the needs.

In one embodiment, the infants or young children are 0-36 months of age, such as 0-12 months or 0-6 months of age. It is foreseen that the composition of the invention may be even more beneficial to infants just after birth (0-4 weeks or 0-8 weeks) as their intestinal tract may be more fragile.

The mammal to be treated is preferably a human being, but the mammal may also be non-human mammal, such as a non-human mammal selected from the group consisting of pig, cow, horse, dog, cat, goat, sheep and rabbit.

In other embodiments, the subject is a juvenile animal, preferably wherein the animal is a pet.

A pet may be a mammal, such as dogs or cats, rodents such as mice, rats, and guinea pigs, rabbits, etc. In some embodiments, the pet is a small dog breed.

The term “juvenile” may refer to an individual that has not yet reached adulthood.

In some embodiments the nutritional composition or combination according to the invention can be for use before and/or during the weaning period.

In some embodiments the nutritional composition or combination according to the invention is for use in a subject at risk and/or in need.

The subject at risk and/or in need may be bottle-fed and/or formula-fed.

In one embodiment the composition or combination of the invention is given to the subject as a supplementary composition to the mother's milk. In some embodiments the subject receives the mother's milk during at least the first 2 weeks, first 1, 2, 4, or 6 months. In one embodiment the nutritional composition or combination of the invention is given to the subject after such period of mother's nutrition, or is given together with such period of mother's milk nutrition. In another embodiment the composition or combination is given to the subject as the sole or primary nutritional composition during at least one period of time, e.g. after the 1^{st}, 2^{nd} or 4^{th} month of life, during at least 1, 2, 4 or 6 months. In one embodiment the nutritional composition of the invention is a complete nutritional composition (fulfilling all or most of the nutritional needs of the subject). In another embodiment the nutrition composition or combination of the invention is a supplement or a fortifier intended for example to supplement human milk or to supplement an infant formula or a follow-on formula.

### Other Ingredients

The nutritional composition or combination according to the present invention may also comprise other types of oligosaccharide(s), polysaccharides and/or a fiber(s) and/or a precursor(s) thereof. The other oligosaccharide and/or fiber and/or precursor thereof may be selected from the list comprising human milk oligosaccharides (HMOs), galacto-oligosaccharides (GOS), fructo-oligosaccharides (FOS), xylooligosaccharides (XOS), cello-oligosaccharides (COS), arabinoxylans, arabinans, xylans, inulin, polydextrose, beta-glucans, pectins and any combination thereof and any derived preparations thereof (e.g. partial hydrolysis). They may be in an amount between 0 and 10% by weight of composition. In a particular embodiment, the nutritional composition or the combination can also contain at least one BMO (bovine milk derived oligosaccharide).

Additional HMOs which may be included in the nutritional composition or combination according to the present invention may be selected from the group consisting of 2′-FL (2′-fucosyllactose), 3-FL (3-fucosyllactose), Lacto-difucotetraose (LDFT)), lacto-N-fucopentaose II, lacto-N-fucopentaose III, lacto-N-fucopentaose V, lacto-N-fucohexaose, lacto-N-difucohexaose I, fucosyllacto-N-hexaose, fucosyllacto-N-neohexaose, difucosyllacto-N-hexaose I, difucosyllacto-N-neohexaose II, para-lacto-N-neohexaose (para-LNnH), LNT (lacto-N-tetraose), LNnT (lacto-N-neotetraose), lacto-N-hexaose, lacto-N-neohexaose, para-lacto-N-hexaose, para-lacto-N-neohexaose, lacto-N-octaose, lacto-N-neooctaose, iso-lacto-N-octaose, para-lacto-N-octaose, lacto-N-decaose, 3′-SL (3′-sialyllactose), 6′-SL (6′-sialyllactose) and any combination thereof.

In some embodiments, the nutritional composition or combination according to the invention comprises at least one additional HMO. In other embodiments, the nutritional composition or combination according to the present invention is devoid of any further HMOs. Thus, LNFP-I may be the sole HMO in the nutritional composition or combination of the invention. Suitably, LNFP-I may be the predominant HMO in the nutritional composition or combination of the invention. By “predominant HMO” is meant that LNFP-I is present in a greater amount than any other HMO in the composition or combination of the invention.

In some embodiments, LNFP-I is the most abundant HMO in the nutritional composition or combination according to the invention.

In some embodiments, LNFP-I is the only HMO in the nutritional composition or combination according to the invention.

In some embodiments, LNFP-I is the most abundant fucosylated oligosaccharide in the nutritional composition or combination according to the invention.

In some embodiments, the nutritional composition or combination according to the invention comprises only fucosylated HMOs.

In some embodiments, the nutritional composition or combination according to the invention does not comprise N-acetylated HMOs.

The nutritional composition of the present invention can further comprise at least one probiotic (or probiotic strain), such as at least one probiotic bacterial strain.

The combination of the present invention can further comprise at least one further probiotic (or probiotic strain), such as at least one further probiotic bacterial strain.

The probiotic microorganisms most commonly used are principally bacteria and yeasts of the following genera: Lactobacillus spp., Lacticaseibacillus spp, Limosilactobacillus spp, Streptococcus spp., Enterococcus spp., Bifidobacterium spp. and Saccharomyces spp.

In some particular embodiments, the probiotic is a probiotic bacterial strain. In some specific embodiments, it is particularly Lactobacilli.

Suitable probiotic bacterial strains include Lactobacillus rhamnosus ATCC 53103 available from Valio Oy of Finland under the trademark LGG, Lactobacillus rhamnosus CGMCC 1.3724, Lactobacillus paracasei CNCM I-2116, Lactobacillus johnsonii CNCM I-1225, Streptococcus salivarius DSM 13084 sold by BLIS Technologies Limited of New Zealand under the designation KI2.

The nutritional composition or combination according to the invention may contain from 10e3 to 10e12 cfu of the at least one (further) probiotic strain, more preferably between 10e7 and 10e12 cfu such as between 10e8 and 10e10 cfu of probiotic strain per g of composition on a dry weight basis.

In one embodiment, the probiotics are viable. In another embodiment, the probiotics are non-replicating or inactivated. There may be both viable probiotics and inactivated probiotics in some other embodiments. Probiotic components and metabolites can also be added.

The nutritional composition according to the invention may contain an additional protein source. Protein sources based on whey, casein and mixtures thereof may be used as well as protein sources based on soy (for example soy protein isolate from Gushen Biological Techn. Group Co. Ltd) and/or rice (for example HyprolRice Advance from Kerry of Ireland). As far as whey proteins are concerned, the additional protein source may be based on acid whey or sweet whey or mixtures thereof and may include alpha-lactalbumin and beta-lactoglobulin in any desired proportions. Suitably, the additional protein source is casein, skim milk, or whole milk. For example, a typical recipe may combine skim milk with the protein source as described herein above to reach the desired casein:whey ratio.

The nutritional composition according to the present invention generally contains a carbohydrate source. This is particularly preferable in the case where the nutritional composition of the invention is an infant formula. In this case, any carbohydrate source conventionally found in infant formulae such as lactose, sucrose, saccharose, maltodextrin, starch and mixtures thereof may be used although one of the preferred sources of carbohydrates is lactose.

The nutritional composition according to the present invention generally contains a source of lipids. This is particularly relevant if the nutritional composition of the invention is an infant formula. In this case, the lipid source may be any lipid or fat which is suitable for use in infant formulae. Some suitable fat sources include palm oil, structured triglyceride oil, high oleic sunflower oil and high oleic safflower oil, medium-chain-triglyceride oil. The essential fatty acids linoleic and α-linolenic acid may also be added, as well small amounts of oils containing high quantities of preformed arachidonic acid and docosahexaenoic acid such as fish oils or microbial oils. The fat source may have a ratio of n-6 to n-3 fatty acids of about 5:1 to about 15:1; for example about 8:1 to about 10:1.

The nutritional composition of the invention may also contain all vitamins and minerals understood to be essential in the daily diet and in nutritionally significant amounts. Minimum requirements have been established for certain vitamins and minerals. Examples of minerals, vitamins and other nutrients optionally present in the composition of the invention include vitamin A, vitamin B1, vitamin B2, vitamin B6, vitamin B12, vitamin E, vitamin K, vitamin C, vitamin D, folic acid, inositol, niacin, biotin, pantothenic acid, choline, calcium, phosphorous, iodine, iron, magnesium, copper, zinc, manganese, chlorine, potassium, sodium, selenium, chromium, molybdenum, taurine, and L-carnitine. Minerals are usually added in salt form. The presence and amounts of specific minerals and other vitamins will vary depending on the intended population.

If necessary, the nutritional composition of the invention may contain emulsifiers and stabilisers such as soy, lecithin, citric acid esters of mono- and di-glycerides, and the like.

The nutritional composition of the invention may also contain other substances which may have a beneficial effect such as lactoferrin, nucleotides, nucleosides, and the like.

The nutritional composition of the invention may also contain carotenoid(s). In some particular embodiments of the invention, the nutritional composition of the invention does not comprise any carotenoid.

This disclosure is not limited by the exemplary methods and materials disclosed herein, and any methods and materials similar or equivalent to those described herein can be used in the practice or testing of embodiments of this disclosure. Numeric ranges are inclusive of the numbers defining the range. Unless otherwise indicated, any nucleic acid sequences are written left to right in 5′ to 3′ orientation; amino acid sequences are written left to right in amino to carboxy orientation, respectively.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within this disclosure. The upper and lower limits of these smaller ranges may independently be included or excluded in the range, and each range where either, neither or both limits are included in the smaller ranges is also encompassed within this disclosure, subject to any specifically excluded limit in the stated range. Where the stated range includes one or both of the limits, ranges excluding either or both of those included limits are also included in this disclosure.

It must be noted that as used herein and in the appended claims, the singular forms “a”, “an”, and “the” include plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The publications discussed herein are provided solely for their disclosure prior to the filing date of the present application. Nothing herein is to be construed as an admission that such publications constitute prior art to the claims appended hereto.

The invention will now be further described by way of Examples, which are meant to serve to assist one of ordinary skill in the art in carrying out the invention and are not intended in any way to limit the scope of the invention.

### Examples

### Materials and Methods

### Experimental Design

B. infantis (LMG11588) fermentations were prepared in the presence of a selection of various carbohydrate sources and protein bodies. A standard growth medium was used for all variants, as described in Table 1 below.

TABLE 1
Standard growth medium formulation

| | % total solids |
|---|---|
| | (TS) of component |
| Component | in Medium |
| Yeast Extract Powder NuCel 582 MG (2506) | 2.000% |
| Yeast Peptone Powder NuCel 581 PW (HYP-A) | 0.500% |
| Yeast Extract Powder FM502 Non-GMO | 1.000% |
| Polyoxyethylene Sorbitan Mono (Tween 80) | 0.150% |
| Vitamin C Sodium Ascorbate | 0.300% |

This medium was then modified for various arms of the experiment, through the inclusion or exclusion of the carbohydrate sources LNFP-I, 2′-FL or GOS, and protein bodies MSK, MSWP80 and WPC (HA). The hydrolysed whey protein concentrate (WPC (HA)) contains hydrolysed mixture of WPC87 and WP195 at a ratio of 37:63 wt/wt, average Mw=1155, rest intact protein <1 wt-%, also called WPC87:WP195 (HA). These designations are given in Table 2 below.

TABLE 2
Designations

| Designation | Component |
|---|---|
| LNFP-I | Lacto-N-fucopentaose I |
| 2′FL | 2′-fucosyllactose |
| GOS | Galacto-oligosaccharide |
| MSK | Skim milk powder |
| MSWP80 | Modified sweet demineralized whey powder |
| WPC (HA) | Hydrolysed whey protein concentrate |

Starting concentrations of each protein body were calculated, as shown in the Table 3 below.

TABLE 3
Starting concentrations of each protein body
within the modified medium formulations

| | Starting concentration | | |
|---|---|---|---|
| | Protein Body Conc. | Tryptophan | |
| Protein Body | (g/L) | (g/100 g) | (g/Dose) |
| MSK | 42.13 | 0.501 | 0.211 |
| MSWP80 | 42.13 | 1.827 | 0.770 |
| MSK + MWSP80 | 15.53 + 26.6 | 1.338 | 0.564 |
| WPC (HA) | 42.13 | 2.022 | 0.852 |

The modified medium contained 0% or 0.5% carbohydrate source, and was supplemented with 42.13 g (dry matter)/L of protein body. The carbohydrate source consisted of LNFP-I, 2′-FL, a combination of LNFP-I and 2′-FL (0.25% each), GOS or a combination of LNFP-I and GOS (0.25% each). A control with no added carbohydrate source was also included. The protein source was either skim milk powder (MSK), whey concentrate powder (MSWP80), partially hydrolysed whey concentrate (WPC HA), or a combination of MSK (15.53 g/L) and MSWP80 (26.6 g/L). A control with no added protein body was also included. The arms and variants of this experiment are shown in Table 4 below.

TABLE 4
Arms and variants of the study

| Variant | Carbohydrate | Protein Body |
|---|---|---|
| 1 | None | None |
| 2 | | MSK (42.13 g/L) |
| 3 | | MSWP80 (42.13 g/L) |
| 4 | | MSK (15.53/L) + MSWP80 (26.6 g/L) |
| 5 | | WPC (HA) (42.13 g/L) |
| 6 | 0.5% 2′-FL | MSK (42.13 g/L) |
| 7 | | MSWP80 (42.13 g/L) |
| 8 | | MSK (15.53/L) + MSWP80 (26.6 g/L) |
| 9 | | WPC (HA) (42.13 g/L) |
| 10 | 0.5% LNFP-I | MSK (42.13 g/L) |
| 11 | | MSWP80 (42.13 g/L) |
| 12 | | MSK (15.53/L) + MSWP80 (26.6 g/L) |
| 13 | | WPC (HA) (42.13 g/L) |
| 14 | 0.25% 2′-FL, | MSK (42.13 g/L) |
| 15 | 0.25% LNFP-I | MSWP80 (42.13 g/L) |
| 16 | | MSK (15.53/L) + MSWP80 (26.6 g/L) |
| 17 | | WPC (HA) (42.13 g/L) |
| 18 | 0.5% GOS | MSK (42.13 g/L) |
| 19 | | MSWP80 (42.13 g/L) |
| 20 | | MSK (15.53/L) + MSWP80 (26.6 g/L) |
| 21 | | WPC (HA) (42.13 g/L) |
| 22 | 0.25% GOS | MSK (42.13 g/L) |
| 23 | 0.25% LNFP-I | MSWP80 (42.13 g/L) |
| 24 | | MSK (15.53/L) + MSWP80 (26.6 g/L) |
| 25 | | WPC (HA) (42.13 g/L) |

### Fermentation and Isolation of Supernatant

All fermentation variants were performed in 10 mL biological triplicate volumes. B. infantis (LMG11588) was inoculated to the modified growth medium at a titre of 2.0E+07 cfu/mL and incubated as a 12-hour static anaerobic monoculture fermentation at 37° C.

Following the 12 h of incubation, all fermentations were sampled for enumeration analysis of B. infantis. This was performed by plating dilutions of the fermentate on MRS agar containing 0.05% L-cysteine, and incubating anaerobically for 48 h, followed by colony counting.

The remainder of each fermentate was centrifuged for 15 minutes at 4,500 rpm, to produce cell-free supernatant. This supernatant was aliquoted into a separate vessel and stored at −20° C. for the metabolite analysis.

### Targeted Metabolomics Analysis

A generic in-house developed methodology was applied for the quantification of a series of bioactive metabolites like:
Polyamines, acetylated polyamines and catabolites such as ornithine (ORN), agmatine (AGM), putrescine (PUT), spermidine (SPD), spermine (SPM), citrulline (CIT), acetyl-ornithine (AcORN), acetyl-agmatine (AcAGM), acetyl-putrescine (AcPUT), acetyl-spermidine (AcSPD), acetyl-spermine (AcSPM), diacetyl-spermidine (DiAcSPD), diacetyl-spermine (DiAcSPM) and cadaverine (CAD). Additionally, samples were analyzed for neurotransmitter gamma-aminobutyric acid (GABA)
Amino acids and acetylated amino acids such as arginine (ARG) (polyamine precursor), tryptophan (TRP), acetyl glutamate (AcGLU) and acetyl lysine (AcLYS).
Aromatic compounds such as indole acetate (IAA), indole lactate (ILA), hydroxy phenyl acetate, phenyl acetate, imidazole acetate, indole propionate (IPA), 3-phenyllactate (PLA), hydroxy phenyl propionate (HO-PPA), phenyl propionate, imidazole propionate and hydroxy phenyl lactate (HO-PLA) and hydroxy-phenyl-hydroxy-propionate (HO-P-HO-PA)
SCFA, acetate, propionate, butyrate, especially acetate and butyrate.

An example of this methodology is provided below.

### Samples

Samples were produced and collected in Eppendorf tubes. Samples were stored at −80° C. until day of analysis after each experimental trial performed.

### Analytical Approach

Analysis was performed using an ultra-high performance liquid chromatography hyphenated to a high-resolution mass spectrometer (UHPLC-HRMS).

### Sample Preparation

Bacterial media samples were stored at −80° C. until the analysis day.

On the day of analysis, samples were thawed at room temperature for at least 1 h, vortexed for homogenization (10 sec) and centrifuged at 12500 g for 10 min at 4° C. in a Thermo Heraeus Fresco 17 centrifuge. An aliquot of 150 μL was taken into an Eppendorf tube and followed by addition of 600 μL of pure methanol. The mixture was vortexed for 10 min at 1500 rpm and left to stand for 5 min at room temperature to allow any precipitation. The samples were centrifuged at 12500 rpm for 10 min at 4° C. in a Thermo Heraeus Fresco 17 centrifuge. The supernatant (720 μL) was transferred into a 96-well plate and evaporated under a stream of gaseous nitrogen flow at room temperature during about 1.5 h. Dried extracts were reconstituted in 135 μL of pure MeOH with in addition, 15 μL of internal standard (ISTD) mix (at a concentration of 125 μM in pure MeOH) to make up a final volume of 150 μL. The samples were vortexed for 10 min at 1500 rpm. Extracts were then transferred into Eppendorf tubes for a centrifugation cycle (12500 rpm for 10 min at 4° C.). Finally, they were transferred into appropriate vial prior to injection.

Calibration ranges were predefined according to the analytical instrument performance and previous work performed on polyamines analysis.

### Analytical Performance Criteria

Each analytical series was evaluated for each compound of interest. In each analytical series, a calibration curve consisting of 9 calibration points with 6 quality control (QC) samples at 3 different levels were injected with the unknown samples. For compound without labelled internal standard, best suited internal standard was selected to allow the quantification on the peak area ratio principle. R² of the calibration curve, coefficient of variation (CV) of individual standard point as well as CVs of QC samples were checked to validate the analysis based on the following: r2>0.98, standard point CV<35% (<40% for lower limit of quantification LLOQ), CV of QC samples <40%.

### Ex Vivo Fecal Fermentation Study

An ex-vivo cryptobiotix fecal fermentation study was performed using the SIFR® technology (Cryptobiotix, Ghent, Belgium). The study was carried out as described by Van den Abbeele et al. Front. Microbiol., April 2023, Vol. 14, DOI: 10.3389/fmicb.2023.1131662.

Five arms were used in the study. These consisted of:
1. Blank
2. LNFP-I
3. LNFP-I+WPC (HA)
4. LNFP-I+B. infantis LMG11588
5. LNFP-I+B. infantis LMG11588+WPC (HA)

The hydrolysed whey protein concentrate (WPC (HA)) contains hydrolysed mixture of WPC87 and WP195 at a ratio of 37:63 wt/wt, average Mw=1155, rest intact protein <1 wt-%, also called WPC87:WP195 (HA).

Each arm consisted of a bioreactor (n=1) seeded with the pooled faecal microbiota of 6 individual donors. The same pool of 6 donors was used for all arms. The study was designed this way to overcome inter-individual biological variability between donors and their microbiota compositions. Donors were 3-month-old infants (±3 weeks) exclusively fed with formulae without HMO/probiotics. The exclusion criteria were antibiotic use in 30 days before sample delivery for the study and previous NEC or gut surgery. This resulted in the enrolment of 6 specific test subjects with an average age of 3.1 (±0.5) months. Intestinal absorption and colonic incubation conditions were then conducted using Cryptobiotix's proprietary “ex-vivo SIFR” protocols (cf. Van den Abbeele et al. Frontiers Microbiol. 2023).

LNFP-I was dosed at a final concentration of 0.03 g/L. WPC (HA) was added at a final concentration of 42.13 g dry matter/L. B. infantis was dosed at a concentration of 5×107 CFU/mL.

Colonic incubations were carried out for 24-hours, with sampling at 0 and 24 hours for SCFA levels by HPLC.

Microbially-produced acetate, butyrate, and total SCFA concentrations were quantified in liquid after 24 h incubation as described in Van den Abbeele et al., 2023.

All possible combinations of WPC (HA) addition (0 g/L and 42.13 g dry matter/L), B. infantis LMG 11588 addition (0 CFU/L and 5×107 CFU/mL), and LNFP-I addition (0 g/L and 0.03 g/L) were assessed.

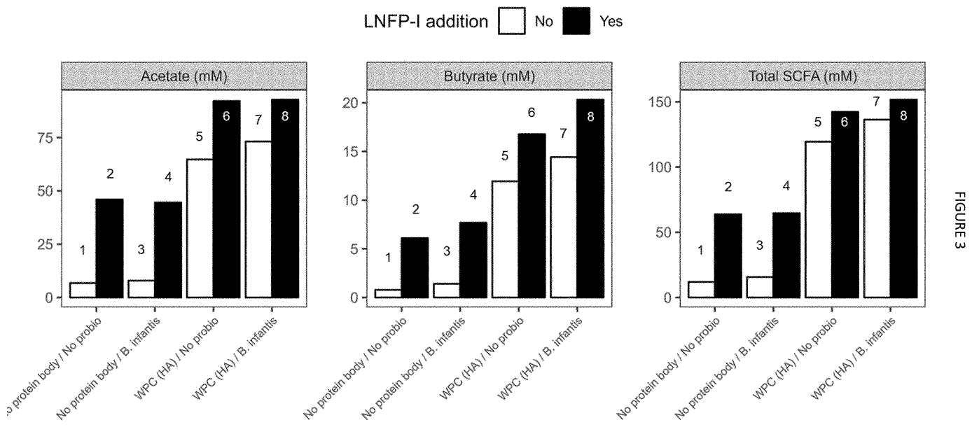

These conditions correspond to bars 1-8 numbered from left to right of FIG. 3. Overall, conditions in which LNFP-I was added show higher concentrations of the selected outputs (differences between white uneven numbered and black even numbered bars). Additionally, conditions in which WPC (HA) was added show higher concentrations of the selected outputs (difference between bars 1-4 bars and bars 5-8). Lastly, conditions in which B. infantis LMG 11588 was added show higher concentrations of butyrate and total SCFAs (difference between bars 1-3, 2-4, 5-7, and 6-8).

Synergy Between WPC (HA) and B. infantis

Another ex-vivo cryptobiotix fecal fermentation study was performed in the same conditions using the SIFR® technology (Cryptobiotix, Ghent, Belgium). The study was carried out as described by Van den Abbeele et al. Front. Microbiol., April 2023, Vol. 14, DOI: 10.3389/fmicb.2023.1131662.

Four arms were used in the study. These consisted of:
1. Blank
2. WPC (HA)
3. B. infantis LMG11588
4. B. infantis LMG11588+WPC (HA)

The hydrolysed whey protein concentrate (WPC (HA)) contains hydrolysed mixture of WPC87 and WPI95 at a ratio of 37:63 wt/wt, average Mw=1155, rest intact protein <1 wt-%, also called WPC87:WPI95 (HA).

Each arm consisted of a bioreactor (n=1) seeded with the pooled faecal microbiota of 6 individual donors. The same pool of 6 donors was used for all arms. The study was designed this way to overcome inter-individual biological variability between donors and their microbiota compositions. Donors were 3-month-old infants (±3 weeks) exclusively fed with formulae without HMO/probiotics. The exclusion criteria were antibiotic use in 30 days before sample delivery for the study and previous NEC or gut surgery. This resulted in the enrolment of 6 specific test subjects with an average age of 3.1 (±0.5) months. Intestinal absorption and colonic incubation conditions were then conducted using Cryptobiotix's proprietary “ex-vivo SIFR” protocols (cf. Van den Abbeele et al. Frontiers Microbiol. 2023).

Colonic incubations were carried out for 24-hours, with sampling at 0 and 24 hours for SCFA levels by HPLC and 3-phenyllactic acid PLA by LC-MS.

Microbially-produced (PLA) and butyrate were quantified in liquid after 24 h incubation as described in Van den Abbeele et al., 2023.

All possible combinations of WPC (HA) addition (0 g/L and 42.13 g dry matter/L) and B. infantis LMG 11588 addition (0 CFU/L and 5×107 CFU/mL) were assessed.

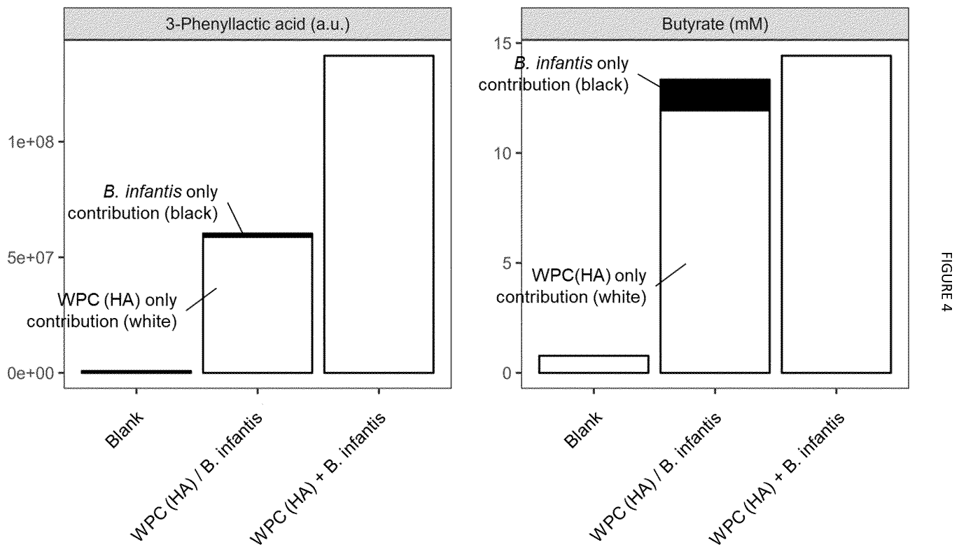

To highlight synergy, i.e., the nonlinear cumulative effects of the interaction between WPC (HA) and B. infantis LMG 11588 when they are jointly present results in increased concentration of these selected outputs compared to their summed individual contributions, we show from left to right the blank condition of FIG. 4 (no WPC (HA) and no B. infantis LMG 11588), the summed WPC (HA) only and B. infantis LMG 11588 only condition, and the condition in which WPC (HA) and B. infantis LMG 11588 were jointly present. Synergy is apparent as the concentrations in which WPC (HA) and B. infantis LMG 11588 were jointly present (rightmost bar) is higher than the summed WPC (HA) only and B. infantis LMG 11588 only condition (middle bar). Individual contributions in the latter condition are shown by coloring them (black for B. infantis LMG 11588 only condition and white for WPC (HA) only condition).

### In Vitro Growth Assays

B. infantis LMG11588 was grown in anaerobic conditions in minimal medium MRS API with 0.25% Glucose overnight. After 16 h growth, this overnight culture was used to inoculate B. infantis LMG11588 at OD 0.05 in MRS API medium supplemented with 0.25% of below listed carbon sources in a total volume of 1200 μL.

The following conditions were tested:
Glucose (positive control)
No substrate, in which no sugar was added (negative control)
LNFP-I
LNT

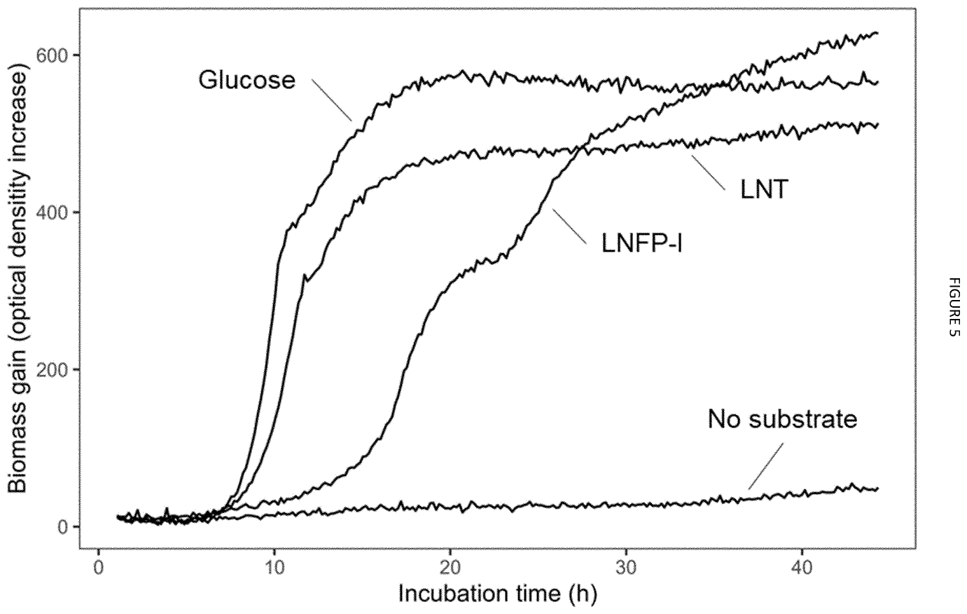

Growth was conducted at 37° C., under anaerobic conditions (CO₂), for 48 hours, without pH control. Initial conditions were set at pH 5.7. Biomass gain was continuously monitored over time to evaluate if the selected carbon sources could support the growth of B. infantis LMG11588. Experiments were conducted in triplicate, with the average being depicted in FIG. 5.

### Results

Bifidobacterium longum subsp. infantis (B. infantis) has the ability to efficiently catabolise a wide array of HMO structures, in particular fucosylated HMO glycans. Among the commonly-occurring fucosylated HMO glycans in breastmilk is LNFP-I. However, due to the difficulty of its production, few studies have investigated the effects of LNFP-I. It was therefore not previously known whether LNFP-I could support the growth of Bifidobacterium longum subsp. infantis as the sole carbohydrate source.

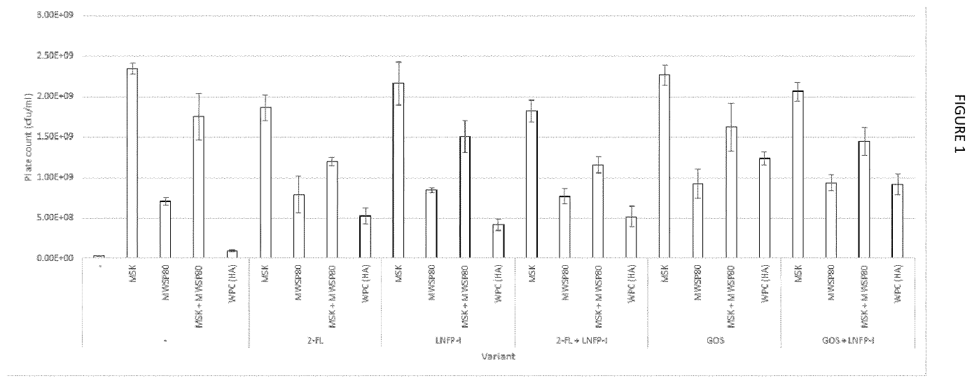

It was found that LNFP-I (4.13E+08 cfu/mL) could support the growth of B. infantis comparably to 2′-FL (5.27E+08 cfu/mL; FIG. 1), but less than the more metabolically-accessible substrate GOS (1.24E+09 cfu/mL). To the best of our knowledge, the present study is the first to evidence the suitability of LNFP-I specifically as a carbohydrate source for the growth of B. infantis.

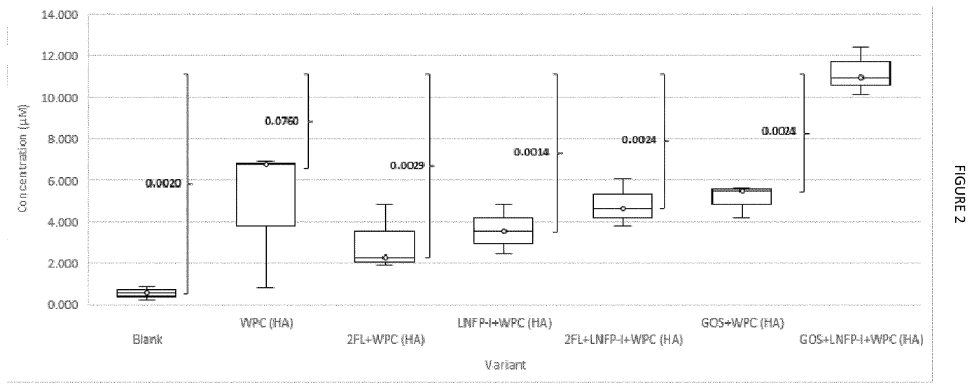

Moreover, it was found that the combination of LNFP-I and GOS increased the production of ILA in the fermentation supernatant (mean 11.164 μM), while concomitantly decreasing the levels of tryptophan, as compared to all other conditions (FIG. 2). This difference reached significance against all conditions, except the condition with the inclusion of the protein body but no addition of carbohydrate source (mean 4.848 μM).

Thus, the combination of B. infantis, LNFP-I and GOS, can significantly elevate levels of the compound ILA, compared to any combination of two of these components, or individually. Importantly, it is evidenced that the levels of ILA are significantly higher when LNFP-I (and GOS) is used rather than 2′-FL (mean 2.999 μM).

Additionally, the protein bodies containing higher starting levels of tryptophan (MSWP80, WPC HA and MSK+MSWP80) also enabled the greater production of ILA. Thus, the protein bodies containing an optimised aminogram enabled the greater production of ILA. These protein bodies have an adapted protein profile and/or an adapted peptide profile.

Hence, the combination of B. infantis, LNFP-I, GOS and a tryptophan-rich protein body, such as a partially hydrolysed whey concentrate, can significantly elevate levels of the compound ILA, compared to any combination of two of these components, or individually.

The Cryptobiotix study carried out demonstrated the effect of the combination of LNFP-I with Bifidobacterium longum subsp. infantis LMG 11588 and WPC(HA) on boosting a microbial derived metabolites that is linked with immune benefits.

Adding LNFP-I increases acetate, butyrate, and total SCFA. The levels of SCFA is further boosted by the addition of Bifidobacterium longum subsp. infantis LMG 11588 and WPC (HA) (FIG. 3).

Remarkably, a synergy between WPC (HA) and Bifidobacterium longum subsp. infantis LMG 11588 was observed even in the absence of LNFP-I (FIG. 4). WPC (HA) and Bifidobacterium longum subsp. infantis LMG 11588 are boosting the microbial derived metabolites 3-phenyllactic acid (PLA) and SCFA, especially butyrate, that are linked to health benefits such as immune protection and antimicrobial properties.

The inventors also performed in vitro growth assays in which B. infantis LMG11588 was inoculated in the presence of several carbon sources. The biomass gain was continuously monitored as a measure of if and how the different carbon sources could support the growth of B. infantis LMG11588 over the course of 48 hours. When no carbon source was added (no substrate), no growth (measured as biomass gain) was observed, whilst the addition of the simple sugar glucose or the less complex HMO LNT resulted in exponential growth that started to stagnate after 10 hours. B. infantis LMG11588 can utilize LNFP-I to grow, and after an adaptation period, a diauxic growth is observed, showcasing that B. infantis is able to utilize LNFP-I as a sole carbon source to ensure increase of biomass.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in molecular biology or related fields are intended to be within the scope of the following claims.

Preferred embodiments of the invention will now be described in the following numbered paragraphs (paras) set A:

1. A combination comprising or consisting of lacto-N-fucopentaose-I (LNFP-I), a LNFP-1 metabolizing Bifidobacterium, for example Bifidobacterium longum subsp. infantis and a galactose source, or a nutritional composition comprising lacto-N-fucopentaose-I (LNFP-I), a LNFP-1 metabolizing Bifidobacterium, for example Bifidobacterium longum subsp. infantis and a galactose source, wherein the galactose source consists of a structure of Formula I:

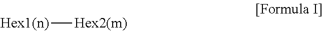

wherein:
Hex1 is galactose,
Hex2 is galactose or glucose,

$$n = 1 - 9 , and$$

$$m = 1.$$

2. The combination or the nutritional composition according to para 1, wherein the LNFP-1 metabolizing Bifidobacterium is selected from the list consisting of: Bifidobacterium lactis, B. longum, Bifidobacterium breve, B. longum subsp. infantis, B. longum subsp. iuvenis, B. bifidum, B. pseudocatenulatum, B. kashiwanohense, and any combination thereof.

3. The combination or the nutritional composition according to para 1 or para 2, wherein the galactose source is selected from galacto-oligosaccharides (GOS), Bovine Milk-derived Oligosaccharides (BMOS) and mixtures thereof.

4. The combination or the nutritional composition according to any one of the preceding paras, wherein the composition further comprises a protein source.

5. The combination or the nutritional composition according to para 4, wherein the protein source comprises tryptophan or a salt thereof.

6. The combination or the nutritional composition according to para 4 or para 5, wherein the protein source comprises an optimized aminogram.

7. The combination or the nutritional composition according to any one of paras 4 to 6, wherein the protein source is enriched in aromatic amino acids.

8. The combination or the nutritional composition according to any one of paras 4 to 7, wherein the protein source has an adapted peptide profile, optionally wherein the adapted peptide profile promotes availability of the amino acids for fermentation by Bifidobacterium species in the large intestine and/or colon of the subject.

9. The combination or the nutritional composition according to any one of paras 4 to 8, wherein the protein source comprises:
a) skimmed milk and demineralized, casein glycomacropeptide (CGMP)-reduced sweet whey;
b) skimmed milk and CGMP-free acid or native whey;
c) CGMP-free whey protein isolate and sweet whey protein concentrate;
d) demineralized CGMP-reduced sweet whey and demineralized sweet whey; or
e) skimmed milk and alpha-lactalbumin-enriched whey protein.

10. The combination or the nutritional composition according to any one of paras 3 to 9, wherein the protein source is an intact protein source comprising:
a) skimmed milk and demineralized, caseino-glyco-macropeptide (CGMP)-reduced-whey;
b) skimmed milk and CGMP-free whey, such as acid or native whey; or
c) skimmed milk and alpha-lactalbumin-enriched whey protein.

11. The combination or the nutritional composition according to any one of paras 3 to 9, wherein the protein source is a partially hydrolysed protein source comprising:
a) CGMP-free whey protein isolate and demineralized sweet whey protein concentrate; or
b) demineralized CGMP-reduced sweet whey and demineralized sweet whey.

12. The combination or the nutritional composition according to any one of paras 3 to 9, wherein the protein source comprises:
a) skimmed milk and demineralized, casein glycomacropeptide (CGMP)-reduced sweet whey;
b) CGMP-free whey protein isolate and sweet whey protein concentrate; or
c) demineralized CGMP-reduced sweet whey and demineralized sweet whey.

13. The combination or the nutritional composition according to any one of paras 3 to 12, wherein the protein source is an intact protein source comprising skimmed milk and demineralized, caseino-glyco-macropeptide (CGMP)-reduced-whey.

14. The combination or the nutritional composition according to any one of paras 3 to 12, wherein the protein source is partially hydrolysed CGMP-free whey protein isolate and sweet whey protein concentrate.

15. The combination or the nutritional composition according to any one of paras 3 to 12, wherein the protein source is partially hydrolysed demineralized CGMP-reduced (e.g. >85% reduced) sweet whey and demineralized sweet whey.

16. The combination or the nutritional composition according to any one of the preceding paras, wherein LNFP-I is present in a total amount of from 25 mg/L to 5000 mg/L of the nutritional composition or of from 0.02-3.75 g/100 g of the nutritional composition.

17. The combination or the nutritional composition according to any one of the preceding paras, wherein the nutritional composition is an infant formula, a starter infant formula, a follow-on or follow-up infant formula, a baby food, an infant cereal composition, a growing-up milk, a fortifier or a supplement.

18. Use of a combination or the nutritional composition as defined in any one of the preceding paras for increasing the levels of indole-3-lactic acid (ILA) in the gastrointestinal tract of a subject.

19. Use of a combination or the nutritional composition as defined in any one of paras 1 to 17 for modulating the microbiota of a subject.

20. Use according to para 19, wherein modulating the microbiota of a subject comprises increasing the abundance of LNFP-1 metabolizing Bifidobacteria, for example Bifidobacterium longum subsp. infantis in the gastrointestinal tract of the subject.

21. The use according to any one of paras 18 to 20, wherein the subject is an infant, a young child or a child.

22. A method of increasing the levels of indole-3-lactic acid (ILA) in the gastrointestinal tract of a subject, the method comprising administering a combination or a nutritional composition as defined in any one of paras 1 to 17 to the subject.

23. A method of modulating the microbiota of a subject, the method comprising administering a combination or a nutritional composition as defined in any one of paras 1 to 17 to the subject.

24. The method according to para 23, wherein modulating the microbiota of a subject comprises increasing the abundance of LNFP-1 metabolizing Bifidobacteria, for example Bifidobacterium longum subsp. infantis in the gastrointestinal tract of the subject.

25. The method according to any one of paras 22 to 24, wherein the subject is an infant, a young child or a child.

26. A combination or a nutritional composition as defined in any one of paras 1 to 17 for use in:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject.

27. The combination or the nutritional composition for use according to para 26, wherein the composition is for use in:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject;
by increasing the levels of ILA in the gastrointestinal tract of the subject.

28. The combination or the nutritional composition for use according to para 26 or para 27, wherein modulating the microbiota of a subject comprises increasing the abundance of LNFP-I metabolizing Bifidobacteria and/or Bifidobacterium longum subsp. infantis in the gastrointestinal tract of the subject.

29. The combination or the nutritional composition for use according to para 18 or para 19, wherein the subject is an infant, a young child or a child.

30. Use of a combination or a nutritional composition as defined in any one of paras 1 to 17 for the manufacture of a medicament for:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject.

31. Use of a combination or a nutritional composition according to para 30, wherein the medicament is for:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject;
by increasing the levels of ILA in the gastrointestinal tract of the subject.

32. The use of the combination or the nutritional composition according to para 30 or para 31, wherein modulating the microbiota of a subject comprises increasing the abundance of LNFP-1 metabolizing Bifidobacteria, for example Bifidobacterium longum subsp. infantis in the gastrointestinal tract of the subject.

33. The use of the combination or the nutritional composition according to any one of paras 30 to 32, wherein the subject is an infant, a young child or a child.

34. A method for:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject,
the method comprising administering a combination or a nutritional composition as defined in any one of paras 1 to 17 to the subject.

35. The method according to para 34, wherein the method is for:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject;
by increasing the levels of ILA in the gastrointestinal tract of the subject.

36. The method according to para 34 or para 35, wherein modulating the microbiota of a subject comprises increasing the abundance of a LNFP-1 metabolizing Bifidobacterium, for example Bifidobacterium longum subsp. infantis in the gastrointestinal tract of the subject.

37. The method according to any one of paras 34 to 36, wherein the subject is an infant, a young child or a child.

38. A combination comprising or consisting of lacto-N-fucopentaose-I (LNFP-I), the strain Bifidobacterium longum subsp. Infantis LMG 11588 (also known as ATCC 17930) and a galactose source, or a nutritional composition comprising lacto-N-fucopentaose-I (LNFP-I), the strain Bifidobacterium longum subsp. infantis LMG 11588 (also known as ATCC 17930) and a galactose source, wherein the galactose source consists of the structure of Formula I of para 1.

39. A nutritional composition comprising a combination according to any of paras 1 to 17 or 38.

40. The combination or the nutritional composition according to any of paras 1 to 17 or 38, the use according to any of paras 18 to 21 or 30 to 33, the method according to any of paras 22 to 25 or 34 to 37, or the combination or the nutritional composition for use according to any of paras 26 to 29, wherein the LNFP-1 metabolizing Bifidobacterium is defined as a Bifidobacterium species or a strain thereof possessing the capacity to hydrolyze alpha 1-2 bound fucose, respectively harbors an 1,2-α-L-fucosidase belonging to the glycoside hydrolase 95 (GH95, see Katayama et al., 2004, J. Bacteriol. 186, 4885-4893). 41. The combination or the nutritional composition according to any of paras 1 to 17 or 38, the use according to any of paras 18 to 21 or 30 to 33, the method according to any of paras 22 to 25 or 34 to 37, or the combination or the nutritional composition for use according to any of paras 26 to 29, wherein the LNFP-1 metabolizing Bifidobacterium is selected from the list consisting of: Bifidobacterium lactis, B. longum, Bifidobacterium breve, B. longum subsp. infantis, B. bifidum, B. pseudocatenulatum and B. kashiwanohense, and any combination thereof.

Preferred embodiments of the invention will now be described in the following numbered paragraphs (paras) set B:

1. A nutritional composition comprising lacto-N-fucopentaose-I (LNFP-I), a LNFP-1 metabolizing Bifidobacterium, for example Bifidobacterium longum subsp. infantis and a galactose source, wherein the galactose source consists of a structure of Formula I:

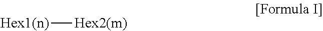

wherein:
Hex1 is galactose,
Hex2 is galactose or glucose,

$$n = 1 - 9 , and$$

$$m = 1.$$

2. The nutritional composition according to para 1, wherein the galactose source is selected from galacto-oligosaccharides (GOS), Bovine Milk-derived Oligosaccharides (BMOS) and combinations thereof.

3. The nutritional composition according to any one of the preceding paras, wherein the composition further comprises a protein source.

4. The nutritional composition according to para 3, wherein the protein source comprises at least one selected in the group consisting of
a) skimmed milk and demineralized, casein glycomacropeptide (CGMP)-reduced sweet whey;
b) skimmed milk and CGMP-free acid or native whey;
c) CGMP-free whey protein isolate and sweet whey protein concentrate;
d) demineralized CGMP-reduced sweet whey and demineralized sweet whey; and
e) skimmed milk and alpha-lactalbumin-enriched whey protein; or a mixture thereof.

5. The nutritional composition according to any one of the preceding paras, wherein LNFP-I is present in a total amount of from 25 mg/L to 5000 mg/L of the nutritional composition or of from 0.02-3.75 g/100 g of the nutritional composition.

6. The nutritional composition according to any one of the preceding paras, wherein the nutritional composition is an infant formula, a starter infant formula, a follow-on or follow-up infant formula, a baby food, an infant cereal composition, a growing-up milk, a fortifier or a supplement.

7. Use of a nutritional composition as defined in any one of the preceding paras for increasing the levels of indole-3-lactic acid (ILA) in the gastrointestinal tract of a subject.

8. Use of a nutritional composition as defined in any one of paras 1 to 6 for modulating the microbiota of a subject.

9. Use according to para 8, wherein modulating the microbiota of a subject comprises increasing the abundance of LNFP-1 metabolizing Bifidobacteria, for example Bifidobacterium longum subsp. infantis in the gastrointestinal tract of the subject.

10. The use according to any one of paras 7 to 9, wherein the subject is an infant, a young child or a child.

11. A nutritional composition as defined in any one of paras 1 to 6 for use in:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject.

12. The nutritional composition for use according to para 11, wherein the composition is for use in:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating the microbiota of a subject;
by increasing the levels of ILA in the gastrointestinal tract of the subject.

13. The nutritional composition for use according to para 11 or para 12, wherein modulating the microbiota of a subject comprises increasing the abundance of LNFP-1 metabolizing Bifidobacteria, for example Bifidobacterium longum subsp. infantis in the gastrointestinal tract of the subject.

14. The nutritional composition for use according to any one of paras 11 to 13, wherein the subject is an infant, a young child or a child.

15. A combination comprising or consisting of lacto-N-fucopentaose-I (LNFP-I), a LNFP-1 metabolizing Bifidobacterium, for example Bifidobacterium longum subsp. infantis and a galactose source, wherein the galactose source consists of a structure of Formula I, wherein Formula I is as defined in para 1.

1: A nutritional composition comprising lacto-N-fucopentaose-I (LNFP-I), a LNFP-1 metabolizing Bifidobacterium, and a galactose source, wherein the galactose source consists of a structure of Formula I: 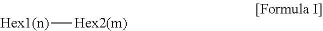
wherein:
Hex1 is galactose,
Hex2 is galactose or glucose,
$$n = 1 - 9 , and$$
$$m = 1.$$

2: The nutritional composition according to claim 1, wherein the LNFP-1 metabolizing Bifidobacterium is selected from the group consisting of: Bifidobacterium lactis, B. longum, Bifidobacterium breve, B. longum subsp. infantis, B. longum subsp. iuvenis, B. bifidum, B. pseudocatenulatum, B. kashiwanohense, and any combination thereof.

3: The nutritional composition according to claim 1, wherein the LNFP-1 metabolizing Bifidobacterium is Bifidobacterium longum subsp. infantis.

4: The nutritional composition according to claim 1, wherein the galactose source is selected from the group consisting of galacto-oligosaccharides (GOS), Bovine Milk-derived Oligosaccharides (BMOS) and combinations thereof.

5: The nutritional composition according to claim 1, wherein the nutritional composition further comprises a protein source.

6: The nutritional composition according to claim 5, wherein the protein source comprises at least one component selected from the group consisting of
a) skimmed milk and demineralized, casein glycomacropeptide (CGMP)-reduced sweet whey;
b) skimmed milk and CGMP-free acid or native whey;
c) CGMP-free whey protein isolate and sweet whey protein concentrate;
d) demineralized CGMP-reduced sweet whey and demineralized sweet whey;
e) skimmed milk and alpha-lactalbumin-enriched whey protein; and
f) a mixture thereof.

7: The nutritional composition according to claim 5, wherein the protein source comprises:
a) skimmed milk and demineralized, casein glycomacropeptide (CGMP)-reduced sweet whey;
b) CGMP-free whey protein isolate and sweet whey protein concentrate; or
c) demineralized CGMP-reduced sweet whey and demineralized sweet whey.

8: The nutritional composition according to claim 5, wherein the protein source is partially hydrolysed CGMP-free whey protein isolate and sweet whey protein concentrate.

9: The nutritional composition according to claim 5, wherein the protein source is partially hydrolysed demineralized CGMP-reduced sweet whey and demineralized sweet whey.

10: The nutritional composition according to claim 1 any one of the preceding claims, wherein the LNFP-I is present in a total amount from 25 mg/L to 5000 mg/L of the nutritional composition or 0.02-3.75 g/100 g of the nutritional composition.

11: The nutritional composition according to claim 1, wherein the nutritional composition is an infant formula, a starter infant formula, a follow-on or follow-up infant formula, a baby food, an infant cereal composition, a growing-up milk, a fortifier or a supplement.

12: A method of increasing levels of indole-3-lactic acid (ILA) in the gastrointestinal tract of a subject, the method comprising administering the nutritional composition of claim 1 to the subject.

13: A method of modulating the microbiota of a subject, the method comprising administering the nutritional composition of claim 1 to the subject.

14: The method according to claim 13, wherein the modulating the microbiota of the subject comprises increasing the abundance of the LNFP-1 metabolizing Bifidobacteria in the gastrointestinal tract of the subject.

15: The method according to claim 13, wherein the subject is an infant, a young child or a child.

16: A method for:
i) preventing and/or treating viral and/or bacterial infections in a subject;
ii) preventing and/or treating necrotizing enterocolitis (NEC) in a subject;
iii) preventing and/or reducing inflammation in the intestine of a subject;
iv) promoting a healthy immune system in a subject; and/or
v) modulating microbiota of a subject,
the method comprising administering the nutritional composition of claim 1 to the subject.

17: The method according to claim 16, wherein the nutritional composition is administered in an amount effective for increasing levels of ILA in the gastrointestinal tract of the subject.

18: The method according to claim 16, wherein the modulating the microbiota of subject comprises increasing an abundance of the LNFP-1 metabolizing Bifidobacteria in the gastrointestinal tract of the subject.

19: The method according to claim 16, wherein the subject is an infant, a young child or a child.

20. (canceled)

21: The method according to claim 12, wherein the LNFP-1 metabolizing Bifidobacterium is Bifidobacterium longum subsp. infantis.
